(19) United States
(12) Patent Application Publication
(10) Pub. No.: US 2025/0297981 A1
(43) Pub. Date: Sep. 25, 2025

(54) Nonlinear Electrochemical Sensor for Monitoring Microbial Growth in Liquids

(71) Applicant: Massachusetts Institute of Technology, Cambridge, MA (US)

(72) Inventors: Michael Aling, Cambridge, MA (US); Kimberley Cheng, Princeton, NJ (US); Billal Iqbal, Allentown, PA (US); Ian W Hunter, Lincoln, MA (US)

(21) Appl. No.: 19/085,011

(22) Filed: Mar. 20, 2025

Related U.S. Application Data
(60) Provisional application No. 63/567,528, filed on Mar. 20, 2024.

(51) Int. Cl. G01N 27/27

(52) U.S. Cl. CPC G01N 27/27

(57) ABSTRACT

An electrochemical sensor extracts information from biofluid systems by harnessing a nonlinear dynamic electrochemical model and stochastic voltage or current input. It uses a black-box approach that describes the fluid's state and predicts its evolution over time using a collection of model parameters, nonlinear dynamic measurement modes, and modeling techniques. For example, the sensor can use principal component analysis to reduce the set of (potentially hundreds) of model parameters to a handful of latent variables which evolve independently of each other. The sensor can use a set of these latent variables as a description of the state of the fluid. For a given sample fluid (e.g., milk containing contaminants), the sensor collects trajectories of the fluid state over time under varying conditions, permitting the training of a machine learning model to predict either fluid state trajectories or time until the fluid state crosses a given threshold (e.g., spoilage).

### CROSS-REFERENCE TO RELATED APPLICATION(S)

This application claims the priority benefit, under 35 U.S.C. 119 (e), of U.S. Application No. 63/567,528, filed Mar. 20, 2024, which is incorporated herein by reference in its entirety for all purposes.

### BACKGROUND

Over the last century, the presence and quantity of microbial hazards—such as bacteria (Escherichia coli, Listeria monocytogenes, Salmonella spp., etc.) and fungi in foods and bodily fluids—has predominantly been assessed through a laborious process of culturing and plate-counting. The plate-counting process requires significant intervention: sampling, dilution, culturing, incubation and optical counting steps are required for each measurement. This can take between two and five days to produce results, depending on the microbiological agent of interest (bacteria and fungi, respectively). Plate-counting can quantify bacteria (for instance, coliforms, psychrotrophic or thermoduric strains), yeast, and mold in liquids in terms of CFU (colony forming units) per mL, where each CFU is assumed to represent approximately one living organism in the original sample. This can either be an aggregate count of all microbiota, or a selective method, via choice of growth medium (e.g., aerobic vs. anaerobic plates) and conditions (e.g., temperature, pH, and headspace gas). It may be manual, as is common in microbiological laboratories, or mechanically automated in part or in whole. Samples may be derived from liquid media, solid surfaces, or the air, prior to culturing.

While modern techniques including polymerase chain reaction (PCR) and enzyme-linked immunosorbent assays (ELISA) have revolutionized sensitivity, response time, and opened new possibilities for microbial and biochemical assessment—in the case of PCR, seeing widespread deployment over the course of the COVID-19 pandemic—they share the requirement of plate counting that a sample must be separated from the medium of study, biochemically treated with reagents, and processed for some time before information can be extracted. As in plate counting, this leads to a great expenditure of time (for manual preparation) or capital (in highly automated systems), as well as a continuous consumption of resources (reagents, growth media, and sterile sample environments). Furthermore, none of these methods are well-suited to continuous monitoring in an “online” sensor format.

A technique for either rapid-response “offline” or continuous “online” microbial monitoring with reduced resource consumption is of significant industrial interest. Potential users include municipal water suppliers (total coliform count, total dissolved solids), wastewater treatment plants (heterotrophic plate count), medical device manufacturers and care facilities (surface and air sampling, device bioburden, and total aerobic/anaerobic plate counts), industrial fermentation for pharmaceuticals and biotechnology (real-time changes in bulk composition of bioreactors, with compensation for the effects of temperature), brewing and distilling (proofing water quality, and contamination of raw materials), and industrial food processing (real-time process monitoring, adulteration detection, product spoilage detection, enforcement of legal CFU limits in products pre- and post-pasteurization, fermentation monitoring, and detection of deviations in raw material from agricultural sources). Other applications may be found in the production of bulk biomolecules (e.g., amino acids, sugars, lipids, enzymes and other proteins) or biochemicals, including acetic acid, biofuels (such as ethanol or biodiesel), and biopolymers (such as bacterial cellulose or polyhydroxyalkanoates), all of which rely on the cultivation of engineered microorganisms.

For similar reasons, microbiologists may see such a technique as a labor-saving mechanism at the individual or laboratory level in a scientific context. The technique may supplement or replace traditional plate counting and flow cytometry or serve as a more robust alternative to other analogs on the bench (commonly pH and optical density methods). The reduction in time and capital expenditure would be significant to research arms of any of the above industries, as well as for independent institutions in academic, medical and regulatory roles.

For an industrial example in the dairy industry, mastitis (a common infection of the udder, affecting 50% of cattle in the absence of antibiotics) can contribute to elevated somatic cell counts, Staphylococcus aureus and Streptococcus agalactiae bacteria at high (up to 10⁷ CFU/mL) concentrations in raw milk. A sensor capable of detecting milk that originated from a cow with clinical mastitis before it is commingled with milk from healthy cows, so that contaminated milk may be diverted from entering a shared vessel, can prevent loss of the commingled product and improve final product quality. At lower bacterial concentrations, detection of subclinical mastitis can lead to preventative treatment for the affected cow, preventing a reduction in milk yield, inflammation and damage to tissues, improving fertility, and forestalling culling by improving the health and quality of life of the animal. Targeted treatment may in turn reduce the need for blanket antibiotic application in dairy herds. This example illustrates multiple economic, animal welfare, and societal incentives for the development of fast-response sensors that monitor microbial populations (in flow processes) and growth (in batch processes).

### SUMMARY

In many of the above applications, microbial growth is accompanied by other changes both in the bulk medium of the sample and at surfaces exposed to the biofluid. Electrochemical sensing methods can detect many of these changes, and readily lend themselves to fast, label-free biosensor architectures that require little to no human intervention. The growth of microorganisms within a fluid can be inferred from the breakdown of macromolecules under the metabolism of bacteria and fungi; changes in the quantity and mobility of charged or electroactive species; changes in viscosity, pH, or dielectric constant; altered surface interactions (e.g., catalytic activity for specific adsorption and/or Faradaic reactions) caused by surface attachment, immobilization and biofilm development; separation of phases in media (e.g., when species fall out of suspension, as in curdling milk, or when new species are produced, as in bacterial cellulose pellicle production or gas evolution); and other sample-specific biochemical or electrochemical interactions. A fast-response sensor based on these electrochemical interactions, for the primary purpose of monitoring microbial growth in liquid media, and a secondary purpose of observing non-biological changes (physical or chemical degradation or evolution over time) in liquid media, is the subject of this disclosure.

An inventive electrochemical sensor can monitor microbial growth in liquid media by using nonlinear stochastic system identification to build a dynamic current-voltage model and tracking changes in this model over time. Such an electrochemical sensor can extract a more complete electrochemical fingerprint from liquid samples than sensors based on traditional linear electrochemical impedance spectroscopy (EIS) or steady-state conductivity, and can do so more quickly than traditional nonlinear electrochemical measurements that use analytically prescribed waveforms.

The electrochemical sensor's components can include (1) the two electrodes that form an electrochemical cell when combined with the liquid sample (which acts as an electrolyte); (2) a temperature sensor that protrudes into the liquid; (3) signal generation electronics that create a large-amplitude (e.g., ±5 V), broadband (e.g., 1 Hz to 1 MHz), stochastic (e.g., Gaussian white noise) voltage waveform across the two electrodes; (4) measurement electronics that read the actual voltage applied across and current flowing between the two electrodes (typically 25 mA peak at 1 Hz to 1 MHz); and (5) one or more processors programmed to periodically generate long (10,000 to millions of samples) Gaussian stochastic input signals and record the resulting outputs (one “measurement”), train a dynamic current-voltage model off the input-output data from one measurement, report the parameters or other characteristics of this model as an electronic fingerprint, and track these fingerprints over time to identify changing electrochemical properties in a sample (in a batch process) or in a continuous feed (in a flow process).

In liquid samples (e.g., food, beverages, water, wastewater, and fermentation or bioreactor environments) that evolve over time under the influence of microbial growth (as macronutrients are broken down, metabolites are produced, and biofilms form on available surfaces), these electrochemical signatures can be correlated to microbial (e.g., bacterial and fungal) population. This results in a low-cost electrochemical sensor that can make indirect, continuous measurements to monitor microbial growth over time in industrial, scientific, regulatory, medical, or consumer settings.

Embodiments of the present technology include an electrochemical sensor including: a signal generator to generate a stochastic waveform; a pair of electrodes, in electrical communication with the signal generator, to apply the stochastic waveform to a liquid; measurement electronics, operably coupled to the pair of electrodes, to measure current flowing through the liquid between the pair of electrodes and/or voltage across the pair of electrodes in response to the stochastic waveform; and a processor, in electrical communication with the pair of electrodes, to create a dynamic model characterizing a relationship between the current and/or voltage and the stochastic waveform in the liquid and to estimate changes in electrochemical properties of the liquid based on changes in parameters or other characteristics of the dynamic model.

The signal generator can generate the stochastic waveform with an amplitude greater than an amplitude at which Faradaic reactions and specific adsorption occur in the liquid. The signal generator can generate the stochastic waveform with a bandwidth spanning from about 1 Hz to about 1 MHz, to facilitate rapid measurement, including in regimes that evoke a capacitive response from the sample.

The dynamic model can include one or more linear and nonlinear dynamic elements, as well as one or more linear and nonlinear static elements.

In some cases, the processor can estimate a set of latent variables that concisely describe complex changes to the parameters of the dynamic model. In these cases, the processor can estimate changes in non-electrochemical properties of the liquid, chemistry of the liquid, and/or microbial content of the liquid based on the parameters of the dynamic model, the set of latent variables, and/or the changes in electrochemical properties of the liquid. The processor may also be configured to distinguish changes in the parameters of the nonlinear dynamic model or in the set of latent variables from the background capacitive response of the liquid sample. The processor may further be configured to predict a future trajectory of changes to the parameters of the dynamic model, the set of latent variables, the changes in electrochemical properties of the liquid, the non-electrochemical properties of the liquid, the chemistry of the liquid, and/or the microbial content of the liquid.

Some examples of the electrochemical sensor can include a temperature sensor, operably coupled to the processor, to measure a temperature of the liquid and/or a temperature controller, operably coupled to the processor, to control a temperature of the liquid.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally and/or structurally similar elements).

FIG. 1A shows a perspective, cross-sectional view of an inventive electrochemical sensor.

FIG. 1B illustrates an inventive electrochemical sensor being used to characterize a biofilm that forms on its electrodes.

FIG. 1C illustrates an inventive electrochemical sensor being used to characterize bulk composition changes in a liquid.

FIG. 1D shows an inventive laboratory-scale multi-sample characterization apparatus with multiple sample containers.

FIG. 1E shows the sample container of FIG. 1A mounted in a temperature control and electrochemical measurement socket with liquid cooling.

FIG. 1F shows an exploded view of the sample container insertion into the temperature control and electrochemical measurement socket of FIG. 1E.

FIG. 1G shows the sample container of FIG. 1A mounted in a temperature control and electrochemical measurement socket with air cooling.

FIG. 2A shows an end-use sensor in the form of a handheld probe for ad hoc process inspection.

FIG. 2B shows the handheld probe of FIG. 2A inserted into a bioreactor or other batch process vessel.

FIG. 2C shows an inventive electrochemical sensor that can be inserted into existing flow process plumbing.

FIG. 2D shows an inventive electrochemical sensor array that can measure biological samples in a well plate, and which exhibits multiplexing.

FIG. 3A shows an inventive electrochemical sensor with functionalized electrode surfaces sensitive to species in the liquid medium.

FIG. 3B shows an inventive electrochemical sensor with raised geometry on or near the measurement electrodes.

FIG. 4A shows an inventive electrochemical sensor with millimeter-scale electrodes patterned on a printed circuit board.

FIG. 4B shows an inventive electrochemical sensor with micro-interdigitated electrodes deposited on a chip.

FIG. 5 shows a Randles equivalent circuit for linear dynamic electrochemical modeling.

FIG. 6A shows linear electrochemical dynamics during a voltage sweep.

FIG. 6B shows nonlinear electrochemical dynamics during a voltage sweep in the Faradaic branch of the Randles equivalent circuit (the nonfaradaic double-layer charging current is added to the nonlinear electrochemical dynamics).

FIG. 7A is a schematic of the working, reference, and counter electrodes typical of electrochemical cells. In a three-electrode measurement, the voltage across one half-reaction (here, O1+e⁻→R1) is isolated for study. In a two-electrode experiment, both half-reactions (and other chemistry) contribute to measured voltage.

FIG. 7B illustrates the working principle of a Ag/AgCl reference electrode.

FIG. 8 shows, at top, input voltage waveforms associated with normal pulse voltammetry (NPV), left; cyclic voltammetry (CV), center; and alternating current (AC) voltammetry (or EIS), right. At bottom, FIG. 8 shows output signatures for analytical analysis in NPV (left), CV (center), and AC voltammetry (right). NPV, CV, and AC voltammetry are shown to provide contrast with the inventive technique.

FIG. 9 shows (left) a stochastic signal typical of the inventive technique, (center) the corresponding probability density function showing a Gaussian amplitude distribution, and (right) the corresponding power spectral density showing a low-pass filtered white noise frequency distribution.

FIG. 10 shows a measurement and modeling equivalent circuit schematic for an inventive sensor. The items within the dashed boundary constitute a modified Randles equivalent circuit, representing the electrochemical cell. Here, the double layer capacitance has been replaced by a generalized linear dynamic element, and the Faradaic branch is represented by a generalized nonlinear dynamic element. A stochastic voltage (or current) is applied at V₁. Voltage is measured at V₁ and V₂. The reference resistor R_{ref} is a physical component, selected by onboard circuits depending on the total apparent impedance of the electrochemical cell (mainly R_{Ω} and H(s)).

FIG. 11A shows a nonlinearity N(s) as identified in statistical aggregate using an inventive Randles-inspired method in aqueous 0.02 M Na₂SO₄ at 1 KHz. Horizontal axis is ΔV′. Vertical axis is i_{b}.

FIG. 11B shows a nonlinearity N(s) expressed as a lower-triangular h₂ kernel in an inventive Volterra model in whole milk at 35° C. and 100 Hz, with a memory length of 64 samples and R_{Ω} incorporated into the Volterra kernel. The Volterra model achieves 94.98% VAF, of which 0.67 percentage points are attributable to inclusion of the h₂ kernel. The datasets in FIGS. 11A and 11B were collected and analyzed using embodiments of the inventive technology.

FIG. 12 shows a comparison of standard Wiener and inventive Randles-inspired models to describe nonlinear behavior in an aqueous solution of 0.02 M Na₂SO₄. Both analysis methods have been performed on the same data. The Randles-inspired model shows clear upticks in faradaic current near the equilibrium potential for water splitting via the hydrogen evolution reaction and oxygen evolution reaction (±1.23 V). By contrast, the traditional Wiener model shows only limited deviations from linear behavior.

FIG. 13 shows Wiener system static nonlinearities collected in aqueous 0.02 M Na₂SO₄, demonstrating the decline of nonlinear behavior as sampling frequency is increased. The model structure of a Wiener system is also shown, including linear portion H(s), nonlinearity n, and internal signal u.

FIG. 14A shows curve-fitting to a static nonlinearity in a traditional iteratively fit Wiener model of ΔV(t) vs. i(t) in aqueous 0.02 M Na₂SO₄ at very low frequencies (1 Hz), using an inverse hyperbolic sine function to describe ΔV(i).

FIG. 14B shows curve fitting to describe the inventive Randles-inspired nonlinearity N(s) in an aqueous 0.02 M Na₂SO₄ solution at 1 kHz. Flatter trace: a cubic function with two parameters. More curved trace: a tri-linear function with exponentially weighted transitions between linear segments, with four parameters.

FIG. 15 illustrates monitoring R_{Ω} in the inventive Randles-inspired model as a function of time for whole milk, held at 35° C. for 24 hours. Spiky trace: the value for each. Stepped trace: an internal modeling variable using the most reliable local estimate for R_{Ω} between several adjacent measurements.

FIG. 16 shows plots of N(s) from the inventive Randles-inspired model for whole milk at 35° C. and 1 kHz. From left to right, selected frames from the progression of N(s) from the start to the end of the experiment (24 hours).

FIG. 17 shows another plot of the phenomenon of FIG. 16, at 1 KHz, where the lowest sampling frequency of the series was kept at 1 KHz. (The experiment from which the data are drawn included a series of measurements at 100 Hz, with greater induced swings in pH.)

FIG. 18 illustrates a method by which envelopes of N(s) in the inventive Randles-inspired model may be (left) identified, and (right) fit as two Gaussian peaks to extract model parameters.

FIG. 19 shows measurements of samples of whole milk at 35° C., evolving over 24 hours under the influence of microbial growth, measured at 100 Hz. Left: A summary of all envelopes for one sample over the time period. Darker envelopes are from earlier in the experiment. The most recent (brightest) envelopes were recorded 4 hours after the end of the experiment, to illustrate additional shifts over time. Right: Example directly identifying local maxima within the envelope after a Savitsky-Golay filter is applied.

FIG. 20 illustrates evolution of whole milk at 35° C. over 17 hours under the influence of microbial growth, measured at 100 Hz. Each plot pane represents the location and height of one of the four peaks of the upper and lower envelopes. Together, this represents a collection of 8 variables that parameterize N(s) in the Randles-inspired model. Darker data points are from carly in the experiment; lighter data points are from later measurements. A light Savitsky-golay filter has been applied. Transient effects at the start of the experiment are visible before the fingerprint settles into a slow evolution for the remaining duration.

FIG. 21 shows principal component analysis (PCA) of EIS spectra for whole milk at 35° C., using transfer functions that span from 5 Hz to 500 kHz. PCA is performed separately for the gain and phase components of the transfer functions. The first three (gain) and two (phase) principal component scores are shown, both as raw data and with trajectories smoothed using a Savitsky-Golay filter.

FIG. 22 illustrates PCA of EIS spectra for various grades of fresh milk as a function of temperature.

FIG. 23 illustrates PCA of the Randles-inspired N(s) envelope for four samples of whole milk at 35° C. over 17 hours. Principal components are ordered from lightest (P1) to darkest (P3). For each of the four samples, PI declines as the milk sample spoils (corresponding to microbial growth in the sample).

FIG. 24 shows linear PCA analysis performed by an embodiment of the sensor when immersed in a temperature-controlled cyanobacteria growth tank (a simple bioreactor). As the bacteria replicate in the presence of visible light and nutrients, a strong growth curve in the first and second principal components of both gain and phase becomes visible. Interruptions beyond hour 7 occur due to intermittent stirring of the reactor (interrupting transport conditions near the electrodes and changing the temperature of fluid near the electrodes).

### DETAILED DESCRIPTION

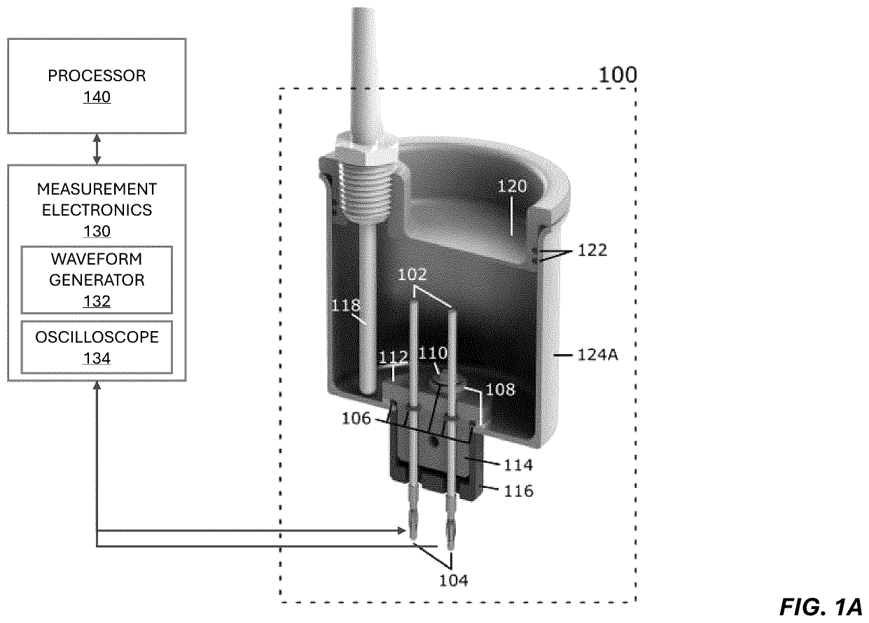

FIG. 1A shows a sample container assembly 100 of an electrochemical sensor that can measure and predict electrochemical properties of biofluids and other chemicals. The sample container assembly 100 includes a sample container 124 that holds a liquid sample (not shown). A temperature sensor 118 sticks down through the lid 120 of the sample container 124 and into the liquid to measure the temperature of the liquid. Optional headspace sealing elements 122 can help seal the lid 120 to the base of the sample container 124, preventing liquid or fumes from escaping the sample container 124 or entry of unwanted biological agents into the liquid sample, and controlling exchange of gasses with the sample.

Measurement electrodes 102 stick up through the bottom of the sample container 124 and into the liquid. Electrical connections 104 at the other ends of the measurement electrodes 102 plug into a socket (not shown) for measurement electronics 130. These measurement electronics 130 may include a waveform generator 132 that generates stochastic waveforms for applying to the liquid and an oscilloscope 134 that processes the current and/or voltage measurements across the measurement electrodes 102. O-rings or other liquid sealing elements 106 and seal retaining rings 108 prevent liquid from leaking from the bottom of the container 124, aided by compressive force from tensioning elements 110, as exerted against components that include wetted clamping element 112 and dry clamping clement 116. The electrodes 102 are held in place by positioning and alignment guide 114.

When filled with liquid, the sample container 124 forms an electrochemical cell with the two measurement electrodes 102. In operation, the measurement electronics 130 produce a stochastic voltage between the two measurement electrodes 102 (the input signal) and record the resulting current flowing between the two measurement electrodes 102 (the output signal). A suitably programmed processor 140 coupled to the measurement electronics 130 (first) creates a dynamic model to characterize the current-voltage relationship in the liquid sample and (second) monitors changes in this model over time. By monitoring changes in model parameters or other model metrics—which relate to electrochemical changes in the bulk media and near-surface conditions—the state of the liquid being monitored can be inferred. In a black-box sense, each measurement produces an electrochemical signature or fingerprint. This signature can be compared to a library of similar samples characterized via existing methods (plate counting, PCR, ELISA, pH, viscometry, spectroscopy, quantification of fat or protein levels, etc.) to arrive at a quantitative estimate of the state of the relevant fluid in terms of the variables that matter most for a given industrial application.

While entry of the electrodes 102 from below the sample container 124 may be advantageous in isolating measurements from complicating interactions near the free surface of the liquid (e.g., liquid fill level variation under evaporation or condensation, as well as pellicle formation or phase separation), the electrodes 102 may enter the sample container 124 from any orientation, including through the lid 120 or as an integral element of the walls of the container 124 and/or lid 120.

FIGS. 1B and 1C illustrate how the electrochemical sensor can detect biofilms and bulk composition changes, respectively. In both cases, the measurement electronics 130 (waveform generator 132) generate a stochastic waveform 101 to apply to the liquid via the measurement electrodes 102. The measurement electronics 130 (oscilloscope 134) also measure the current through the liquid between the measurement electrodes 102 and/or the voltage across the measurement electrodes 102. In both cases, these outputs 197, 199 contain information representing the system dynamics, which the processor 140 extracts and uses to track formation of a biofilm 97 on or near the measurement electrodes 102 (FIG. 1B) and/or composition and property changes 99 of the bulk liquid (FIG. 1C).

While the perturbation signal 101 is described as an applied voltage, it may also constitute an applied current depending on the configuration of the measurement electronics 130 and desired operation of the processor 140.

FIG. 1D shows a benchtop (300 mm×250 mm×800 mm) instrument 150 that can be used to study nine fluid samples simultaneously in autoclavable, individually heated and cooled containers 124 (which can reach −5° C. to 70° C. in aqueous media). Temperature is controlled using nine solid-state thermoelectric coolers 200, which can both heat and cool the sample, and a proportional-integral-derivative (PID) temperature control loop using low-pass-filtered, pulse-width-modulated (PWM) temperature controllers 136 to reduce switching noise. This control loop holds the samples to a target temperature within ripples of typically ±0.1° C. Temperature inhomogeneity across the sample may be negligible when not rapidly ramping temperature. A water-cooling loop with coolant distribution piping 154, radiators (coolant heat exchangers) 228, and pumps 158 rejects waste heat from the thermoelectric coolers 200. Nine onboard function generators 132 (10 MHz, ±5V) and oscilloscopes 134 (100 MHz) serve as the measurement electronics 130 for the respective sample containers 124.

Each 80 mL sample container 124 is equipped with its own set of two electrodes 102, rising from the bottom of the container 124 so they may remain fully submerged as shown in FIGS. 1A-1C. These electrodes mate to a socket on the upper surface of the instrument, which is nested in the center cavity of the annular thermoelectric cooler and water circulation block and is described below. When making the electrical connection to the sample, the sample container 124 (316 stainless steel) is pressed against a compliant thermal pad that conducts heat between the sample container 124 and the thermoelectric device 200. Temperature sensors 118 (e.g., thermocouples or resistance temperature detectors) are inserted into the sample from above, integral to the container lid 120. Surrounding each sample container 124, a shroud can be installed to prevent convection and improve insulation of the sample, making temperature shifts more rapid and extending the accessible temperature range. Measurements can be performed in parallel operation across the nine samples at a sampling rate of up to 100 kHz, using arbitrary-length stochastic inputs that are fed continuously into the buffer of each waveform generator 132. (Higher frequencies, e.g., up to 10 MHz, are possible in sequential, rather than parallel measurement modes, and when shorter signals that fit entirely within the buffer are employed.) The oscilloscopes 134 can record arbitrary-length signals. Experimental control software automates this process for the user.

When using this instrument 150 to create a library of electrochemical fingerprints, many conditions can be controlled and varied: temperature and time of exposure, chemical (e.g., macronutrient) and microbial (e.g., starting CFU/mL and dominant strain) variations in the sample material, exposure to headspace gasses above the sample, exposure to lighting, and chemical conditions used on the sample during industrial processing. This instrument 150 can be used to perform experiments on several samples at once, to rapidly scan different conditions.

To make the library more useful, the samples can be separately characterized with other laboratory tests so that the electrochemical fingerprints can be related to physical parameters relevant to the electrochemical sensor. This may include species-selective plate counting, spectroscopy, pH measurements, viscometry, or chemical analysis by various means, to name a few options. Once the library is established, the electrochemical sensor may be introduced or substituted into an industrial or laboratory process in place of more expensive sensors that make direct measurements of the preceding phenomena.

The instrument may also be used to characterize new sensor heads, electrode materials (e.g., studying degradation in various media), sample containers, temperature control schemes, and measurement electronics.

FIGS. 1D and 1E illustrate the sample container assembly 100 of an electrochemical sensor mounted in a liquid-cooled sample measurement socket 200A suitable for use on its own or as part of a multi-sensor instrument like the one shown in FIG. 1C. Measurement electrodes 102 connect through a measurement socket body 204 to the measurement electronics 130 (FIG. 1A) via respective measurement socket connections 202. A measurement socket support plate 206 holds up the measurement socket body 204 with tensioning elements 208 that attach the socket 204 to a mounting plate (not pictured) and to temperature control elements (including a temperature control device 216, thermal contact plate 218A, and coolant circulation assembly 210).

Because both electrical and thermal contact with the sample is desirable, the socket support plate 206 also makes it possible to adjust the spacing between the measurement socket body 204 and the temperature-controlled plate 218A. In this way, by maintaining sliding contact with some tolerance between the electrical connectors 202 and 104, and surface contact between sample container 124 and thermal plate 218A, with some tolerance from a compliant thermal pad or compound 220, both temperature and electrical communication may be maintained with the sample, while the sample container assembly 100 remains removable.

While it is desirable for both electrical 202 and thermal 220 contact to be easily broken and reestablished with the liquid sample container assembly 100, one or both may also be maintained permanently.

Additionally, temperature control may take many forms, several of which are described below. Most forms of temperature control do not require any specific placement of the temperature control elements with respect to the sample container 124 or lid 120 so long as they are in thermal contact. The temperature control elements may therefore be placed in any orientation with respect to the sample container 124 so long as thermal contact is maintained.

FIG. 1F shows the insertion of the sample container assembly 100 into the temperature-controlled measurement socket 200. Inserting the sample container assembly 100 into the electrical socket 204 also presses the bottom of the container assembly 100 against a temperature-controlled plate 218A that is in thermal contact with a temperature control device 216, such as a bidirectional thermoelectric cooler, that keeps the container's contents (i.e., the liquid being monitored) at a desired static temperature or causes the container's contents to follow a temperature program, either above (heated) or below (refrigerated) ambient temperature, or both. A coolant circulation assembly 210 circulates liquid coolant through a coolant channel 214, removing waste heat from or supplying environmental heat to the temperature control device 216. A coolant heat exchanger 228 removes heat from or supplies environmental heat to the liquid coolant. The coolant and coolant channel 214 may be at room temperature, elevated, or refrigerated temperatures depending on the temperature control scheme. Coolant sealing elements 212 prevent the liquid coolant from leaking out of the coolant channel 214. Thermal compound 220 between the liquid-cooled cold plate 218A and the bottom of the sample container assembly 100 improves thermal conduction between the temperature-controlled plate 218A and the sample container assembly 100. If desired, a mounting plate 226 can hold the entire socket/sensor assembly in a sample module array, e.g., as in the multi-container instrument 150 of FIG. 1D.

A thermal insulation shroud 222, with thermal insulation lid 224 to permit removal of sample container assembly 100, may be employed to insulate the sample container assembly 100 and temperature-controlled socket 200 from the ambient environment.

FIG. 1G shows the sample container assembly 100 of an electrochemical sensor mounted in an air-cooled sample measurement socket 200B. In this embodiment, an intermediate coolant fluid is not used, and the ambient air is instead passed directly over a heat sink 250 in contact with the temperature control device 216 (for instance, a bidirectional thermoelectric cooler). As before, the container 124 is pressed against to a temperature-controlled plate 218B as the electrode connectors 104 are inserted into the electrical measurement socket 204. A heat sink clamping clement 252 holds the air-cooling heat sink 250 against the temperature control device 216, and the temperature control device 216 against the temperature-controlled plate 218B. An air-cooling fan 256 blows cool air through an air-cooling nozzle 254 across the air-cooling heat sink 250. An air-cooling spacing and support structure 258 holds the air-cooling fan 256 off the ground (or off the mounting plate, in the case of a sample array as in multi-sample measuring instrument 150) to allow airflow.

In other embodiments, the temperature control element 216 may be a unidirectional heater instead of a bidirectional thermoelectric device. If it is a unidirectional heater, the coolant channel can be omitted, in which case the temperature control device 216 heats the container 124 without cooling it. Alternatively, the temperature control device can be augmented or replaced by the air- or liquid-coolant circulation loop, through the circulation block 210. The block 210 may, for instance, circulate refrigerated coolant to supply a bias towards temperatures below ambient, while a unidirectional heater takes the place of the temperature control device by providing fine adjustment of temperature through variable heating, while also allowing access to temperatures above ambient with application of sufficient heating power. If the fine-control element 216 is completely omitted, then external temperature control is used for the circulating coolant to heat or cool the sample container assembly 100 by placing the coolant circulation block 210 in direct contact with the temperature-controlled plate 218A.

### End-Use Sensors

Inventive electrochemical sensors fall broadly into two categories: (1) laboratory instruments like those shown in FIGS. 1A-1G, which measure and control the temperature of the sample and can be used to construct libraries of electrochemical fingerprints at various temperatures and sample conditions, and (2) end-use sensors, which perform similar electrochemistry, and measure but do not control the temperature of the sample. Category (1) generally provides sanitary, heated and cooled conditions for the samples, while hosting the electrodes and measurement electronics for multi-sample measurements. Category (2) is generally introduced into a user's process, relying on the sanitation and temperature control conditions already in use, providing the electrodes and measurement electronics to conduct the measurement. Both types of sensors can include electrodes made of stainless steel (grades 304 and 316) rods or other materials or types as explained below.

End-use sensors share many characteristics with laboratory instruments, including similar or identical measurement electronics and electrodes (spacing, geometry, and material). However, end-use sensors can be simpler than laboratory instruments: for example, an end-use sensor may include only one sample head and one set of measurement electronics and may measure temperature without controlling it.

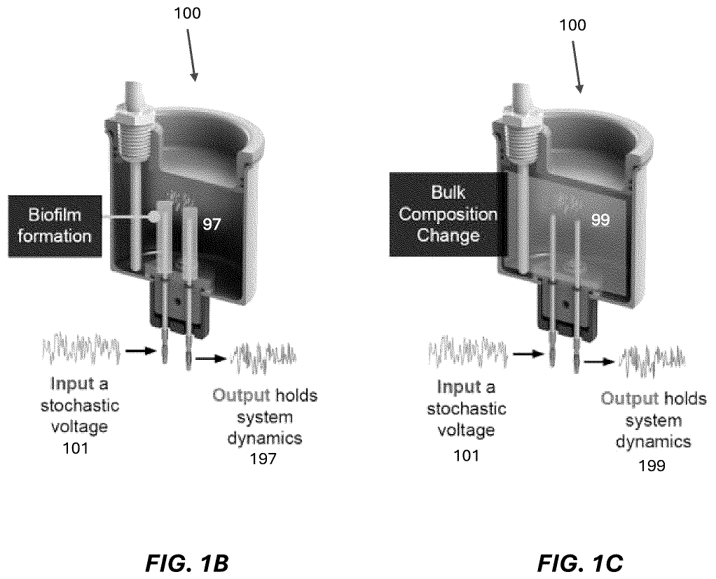

FIG. 2A shows an end-use sensor in the form of a handheld inspection probe 300 for use by scientists and engineers in industrial or research environments. This probe 300 enables rapid trials of candidates for electrochemical fingerprinting, and/or inspections to verify proper operation of previously characterized industrial processes. These inspections may be carried out by the relevant facility itself, or by third parties verifying regulatory compliance. This handheld inspection probe 300 includes a handheld sensor body 302 that either contains or connects to measurement electronics 130 (waveform generator, oscilloscope, and temperature sensor conditioning circuit), which is coupled to a processor 140 by a digital communication line 308 (the processor 140 could also be contained in the handheld sensor body 302). One or more analog communication lines 304 connect the measurement electronics 130 to a handheld unit 302 that includes the measurement electrodes 102 and temperature sensor 118, which can be inserted to the liquid under study. This liquid can be contained in a separate sample container 124 not connected to the probe 300.

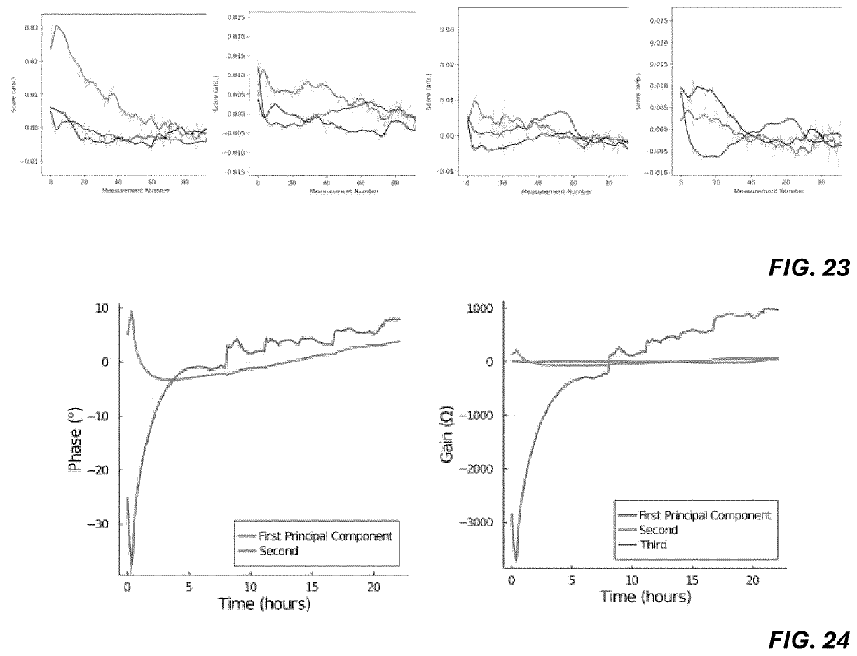

FIG. 2B shows the handheld unit 302 inserted into a batch process vessel 502 for batch for process monitoring. (FIG. 24 (below) shows data from this demonstration.) The measurement electrodes 102 and temperature sensor 118 stick through a sensor port and adapters 506 into the body of the batch process vessel 502. As one example of a batch process, the vessel 502 may be a stirred, temperature- and illumination-controlled bioreactor to produce cyanobacteria. The measurement electrodes 102 and temperature sensor 118 can be inserted in any orientation and mounting location with respect to the vessel 502, provided that they do not touch or interfere with the vessel's components, which can include a stirring agitator 504A, stirring motor and couplings 504B, and temperature control devices 504C. Batch process vessel sealing and clamping elements 508 maintain sterile conditions and provide structural support. The handheld unit 302 may be removed for cleaning or to monitor other reactors. Other versions of this end-use sensor may be designed as integral elements to the vessel. The end-use sensor 500 may rely on the batch process vessel's temperature sensor and/or temperature control system or include its own temperature sensor.

FIG. 2B is only one example of an inventive sensor being integrated into a batch process. The sensor is portrayed using the handheld unit 300 of FIG. 2A to demonstrate that it may be easily installed into or removed from the vessel. The electrodes 102 and temperature sensor 118 may instead be directly integrated into the body of the batch process vessel 502, as they are into the sample container assembly 100 of FIG. 1A. This manner of direct integration is shown for flow processes in FIG. 2C, which is described below.

The batch process vessel 502 may equivalently embody a continuous stirred tank reactor supporting a flow process that is homogenized in the vessel 502 rather than being allowed to vary across the length of a pipe or reactor 402 (FIG. 2C).

FIG. 2C shows an end-use sensor 401 integrated into existing industrial components for batch or flow processes. The end-use sensor 401 may be installed inline to existing flow process piping 402 with sealing elements 404 and/or clamping elements 406, e.g., in pipes or joints, at filling stations, in agricultural harvesting equipment (e.g., milking machines), in chemical reactors and bioreactors, or food and beverage fermentation equipment. The measurement electrodes 102 and other components are held in place by a sensor housing adapter 408, which is mated to the piping with sealing elements 410, such that the measurement electrodes 102 extend into the pipe. In this case, the measurement electrodes 102 are perpendicular to the fluid flow direction 400, but they could be oriented in other directions with respect to the fluid flow direction 400. For instance, the sensor housing adapter may take different forms, including an inline configuration rather than the tee configuration in FIG. 2C. A temperature sensor (not shown) can also stick into the fluid, or the temperature reading may be taken from the flow process control parameters, eliminating the need for a temperature sensor.

Such an end-use sensor 401 may also be integrated alongside an array of other low-cost sensors (pH, optical absorption, pressure, and flow speed) in smart multi-sensor packages. When integrated into industrial processes, the fingerprints produced by the end-use sensor 401 may be used (by computer systems or human operators) to make operational judgments, triggering actions (e.g., valve closure, flow reduction, temperature adjustments, or other control equipment) that affect the process being controlled. This may even take the form of a closed-loop control system optimizing for a given state of the liquid sample. The same may be true for end-use sensors 302 installed into batch process vessels 502 (FIG. 2B).

FIG. 2D shows an end-use sensor array 800 that is compatible with standard well plates 802 that are in widespread use for microbiological experiments. Each of the 24 wells in the plate 802 is analogous to the sample container 124 of FIGS. 1A-1G, and may house different samples or support different growth conditions. In this embodiment, and owing to the small size of the wells, a variety of electrode pairs 102 are in analog communication with a single set of measurement electronics (not pictured) and a single processor (not pictured) via analog connection ports 304. Communication is mediated by a set of multiplexing electronics 806 that permits sequential measurements in a single well at a time. Depending on the control state of the multiplexing electronics 806, two electrical pathways exist, through a printed circuit board (PCB) 805, and incorporating the onboard reference resistor 808, between one pair of electrodes 102 and the shared measurement electronics 130. In this way, a single set of measurement electronics 130 may be shared across many samples, in contrast to the architecture of the larger multi-sample characterization device 150 (FIG. 1D), in which each sample container assembly 100 is paired with a corresponding set of measurement electronics 130. The PCB 805 is mounted as a lid to the well plate 802 using a structural brace 804 that may be fastened using screws (not pictured).

As with the sample container assembly 100 of FIG. 1A, the electrodes 102 may enter with any orientation to the well plate 802, including from below. As with end-use sensors 302 and 401, the multiplexed sensor 800 may be either removable from or integral to well plate 802, which may itself be an existing element of the laboratory or may be a customized component inseparable from the inventive sensor. While well plate 802 is portrayed as a 24-well plate in FIG. 2D, any number of wells (e.g., 6, 12, 48, 96, 384, or 1536 wells) may be used with appropriately sized electrodes 102. As depicted in FIG. 2D, the well plate 802 can be temperature controlled by its presence in an external incubator. A temperature control system analogous to that of FIG. 1E or 1G may be included for either heating and cooling of individual wells, or for heating and cooling at the whole-plate level. A temperature sensor 118 may be included along with each electrode pair 102, or with the whole plate 802.

The well plate form factor 800 of the inventive sensor is particularly advantageous when considering the small volume of liquid sample contained in each well. Methods exist to quantify microbial populations at the start and end of an incubation period as a concentration of colony forming units (CFU/mL), primarily by optical plate counting. However, these methods involve withdrawing a portion of the medium for analysis, disturbing the sample (including its temperature control, pellicle formation, sample volume, and nutrient distribution). For small wells, each population measurement may consume or destroy the contents of an entire well. Constructing a growth curve via these methods alone would require sacrificing one well for each data point. By contrast, an inventive continuous electrochemical monitoring system can smoothly interpolate between the initial and final CFU/mL measurements provided by more invasive methods and/or replace those methods entirely. On a 24-well plate, this would mean the difference between acquiring a single growth curve with 24 data points via optical plate counting and acquiring 24 separate growth curves each with hundreds or thousands of data points via the inventive sensor 800. An entire study could be carried out on a single plate, instead of a stack of laboriously prepared and incubated plates. Other analogs like optical density methods can operate in a similar manner in a well plate form factor but are sensitive to turbidity and media pigmentation, unlike the inventive electrochemical sensors.

In an alternative embodiment, the present technology may also be used by consumers when integrated into smart containers that carry liquid products, including integration into existing transport vessels and vehicles (e.g., tanker trucks; refrigerated transport containers for shipping by air, land, or sea; disposable food packaging; or packaging for high-value cosmetics, supplements, medication or medical biofluid transport). In many of these cases, it is beneficial for the sensor head to be removable from the measurement electronics. In some cases, the sensor head may be disposable. Sockets for this removable functionality can be the same as or similar to those in laboratory instruments.

### Electrodes for Electrochemical Sensors

The materials and geometries of the inventive sensor's measurement electrodes allow similar inventive sensors to take on very different measurement and/or construction characteristics with minimal changes to core components and methods.

### Non-Noble Metal Electrodes

In applications using sufficiently low current and high frequency—so that pH cannot build up at the electrode surface to either acidic or basic extremes—a bare stainless steel surface (e.g., grade 316) can besufficient for construction of an inventive electrochemical sensor's two electrodes.

This is a unique benefit of performing nonlinear stochastic system identification at high frequency. Lower frequency input signals, or those with a defined structure (e.g., steps, sweeps, staircase waveforms, and sinusoids), are more prone to pH buildup, corrosion, and corruption of the sample medium (e.g., by interaction of local pH extremes with the sample), by virtue of driving current in one direction for longer periods of time. A high-frequency stochastic signal which frequently reverses direction mitigates these effects.

Depending on the application, the use of bare stainless steel or other non-noble materials may represent significant cost savings. This also results in a more robust sensor that may be abraded, etched, or routinely cleaned without damaging the thin noble metal layers that are common on electrodes in other techniques. This makes the sensor well-suited for integration into existing industrial environments.

### Noble Metal Electrodes

In cases of an acidic medium, lower frequency, or higher currents, materials with a greater region of stability (determined from Pourbaix diagrams) may be plated onto or wholly substituted for the steel electrodes. Suitable coatings include gold and platinum coatings, both of which resist corrosion over wide operational regimes.

Other metal oxide and nonmetal (e.g., carbon) coatings or substrates may be better suited for asymmetric waveforms with a nonzero mean, where the input signal is biased to make one electrode more negative and the other more positive. (In this arrangement, it can be known in advance which electrode will develop higher acidity and which will develop higher alkalinity, and specialized coatings or electrode bodies can be applied.)

These substitutions may involve changes in catalytic activity of the electrodes. Beyond considerations of stability, an inventive sensor may intentionally harness differences in catalytic activity to tune the desired current or voltage range, to introduce asymmetry into the electrochemical cell, and/or to probe specific interactions with the sample medium.

### Specialized Electrodes

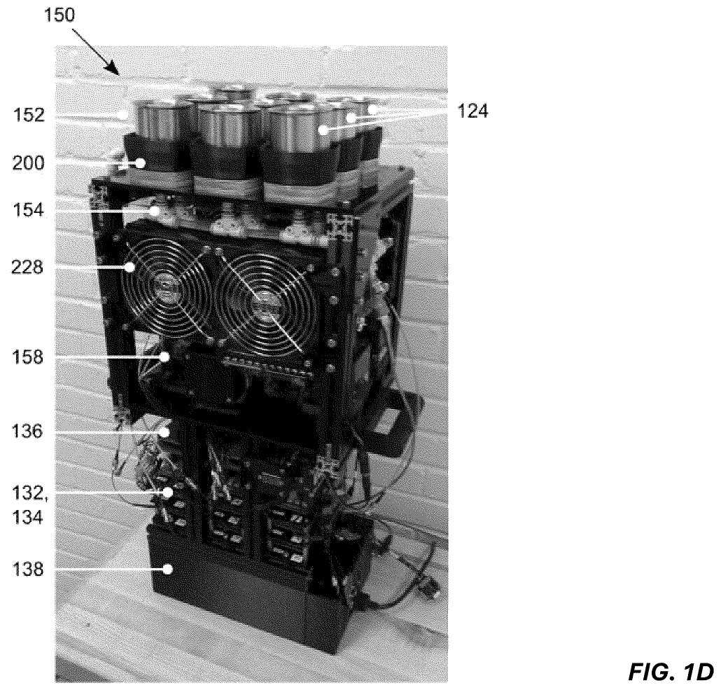

Several contemporary advances in electrochemical biosensing have relied on specialization of the electrodes themselves for greater specificity in identifying biological, biochemical, and/or inorganic chemical constituents. Specialized electrode materials and surface treatments, either of a catalytic or a biochemically functionalized nature, can be used to improve the specificity of an inventive sensor by interacting with specific electrochemically active species in the sample medium, or by trapping agents of interest (biological agents, larger particles, or adsorbed chemical species) close to the electrode surface, as shown in FIGS. 3A and 3B.

Functionalization can, for example, be used for screening raw materials for the pharmaceutical industry via surface immobilization of bacteria or for detecting immunochemical or enzymatic reactions, DNA hybridization events, and the adsorption of molecular assemblies.

Bacteria can be intentionally immobilized on biochemically functionalized surfaces on or near the microelectrodes to take advantage of the present technology's increased sensitivity to surface effects—an example of an inventive biosensor comprising a physicochemical transducer and a biochemically active structure that imparts specificity to biochemical compounds or biological agents.

Microfluidic devices can be utilized to amplify surface sensitivity or intentionally concentrate bacterial species via dielectrophoresis, either into an adjacent measurement chamber, or at choke points between the interdigitated electrodes.

Surface geometry can also be exploited to force charge transfer along winding paths close to the device's functionalized surface to aid in the detection of biomolecules and other chemical species.

FIG. 3A shows an inventive sensor with measurement electrodes 102A and 102B that have been functionalized by attaching specialized molecules or structures 172A and/or 172B. Certain functional structures 172A can exhibit specific interactions with inorganic and/or biochemical species and/or particles 174A in the liquid medium. Other functional structures 172B can exhibit specific interactions with living or dead biological agents 174B in the liquid medium. In either case, these interactions can include trapping the relevant species close to the surface, thereby altering the near-surface electrochemical properties and enhancing sensitivity to and selectivity for the relevant species. The electrodes 102 are supported by an insulating substrate 170.

FIG. 3B shows an inventive sensor with measurement electrodes 102A and 102B with the inclusion of local geometric variations of the insulating substrate 170 and/or the measurement electrodes 102 themselves. The inclusion of these geometric variations, which may be two- or three-dimensional, can create a distinction between near-surface 176 and bulk 178 current pathways in the liquid medium. An inventive sensor may use this distinction in combination with a dynamic model to distinguish between changes in surface and bulk conditions in the liquid medium. To enhance this effect, functional structures 172 may be coated onto the geometric features of either the substrate 170 or the measurement electrodes 102.

### Miniaturized Electrodes

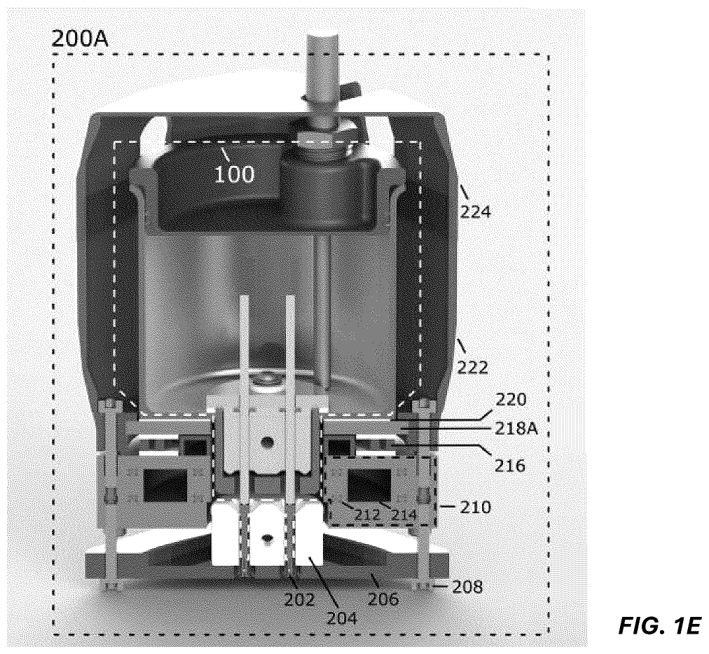

An inventive sensor can also incorporate electrode miniaturization techniques. Miniaturization of electrodes is associated with (1) suitability for significantly higher frequency (therefore faster) measurements, as the transport boundary layer approaches the length scale of geometric features on the electrodes, (2) lower material usage and spatial footprint of the electrodes, resulting in smaller, lower-cost sensor heads, (3) a corresponding reduction in the minimum required volume of the liquid sample, and (4) a reduction in necessary current supply, as the electroactive surface area is reduced, leading to smaller measurement electronics and lower energy consumption. In contrast with macroscopic metallic electrodes, these miniature electrodes may adopt a printed circuit board (PCB, FIG. 4A) or micro-interdigitated (FIG. 4B) form factor. When so constructed, these sensor heads may also be of a disposable nature and integrated into packaging or test strips in communication with an inventive sensor.

FIG. 4A shows an electrode pattern suitable for the millimeter scale, such as on a printed circuit board (PCB), that comprises the sensing element of an inventive sensor. The measurement electrodes 102 are deposited directly onto the PCB substrate 180. These are operably coupled via PCB traces to electrical connection pads 104 that are in turn operably coupled to measurement electronics 130 (not pictured). The electrodes 102 may be symmetric or asymmetric, of similar or different coatings, and of various geometric designs. Furthermore, a miniaturized temperature sensor 118 (not pictured) may for instance be included as a surface-mount component on the same PCB 180, resulting in an all-in-one sensing component suitable for mass production.

FIG. 4B shows an electrode pattern suitable for the micron scale, such as on an appropriately etched and deposited silicon chip, that comprises the sensing element of an inventive sensor. The measurement electrodes 102 are deposited directly onto an insulating substrate 170. These are operably coupled via deposited features to electrical connection pads 104 that are in turn operably coupled to measurement electronics 130 (not pictured). The electrodes 102A and 102B, and connection pads 104A and 104B, may be of differing materials or coatings, to enhance selectivity. The electrodes 102A and 102B may further be of an interdigitated design, as pictured in FIG. 4B, increasing sensitivity while minimizing physical distance between the two electrodes. Furthermore, a miniaturized temperature sensor 118 (not pictured) may be included on the same chip 170, resulting in an all-in-one sensing component suitable for mass production.

Microfabrication can significantly reduce transport time constants, ensure small bulk transport resistance R_{Ω} in comparison to surface and capacitive effects, and lead to unique behavioral regimes (since the electrode length scales are on par with the transport boundary layer). Furthermore, at sufficiently small scale, geometric features on the electrodes may be of a similar length scale as particles or biological agents of interest in the liquid medium. For example, an individual bacterium may span the distance between two arms of a micro-interdigitated electrode. This can make new phenomena, such as cytometry, accessible to an inventive sensor.

While certain electrode materials, surface treatments, and morphologies are known to be of use for this sensor, the inventive technique is compatible with and may reasonably be extended to contemporary and future developments in measurement electrode technology, without appreciable changes to the two-electrode electrochemical cell architecture, measurement electronics for generation and acquisition of stochastic signals, and processor configuration. The inventive sensor may therefore be combined with other measurement technologies.

### Comparison With Electrochemical Impedance Spectroscopy (EIS)

Like an electrochemical impedance spectroscopy (EIS) sensor, an inventive electrochemical sensor uses a readily miniaturized two-electrode cell, perturbs the cell using current (or voltage), reads the voltage (or current), and builds a dynamic model. Unlike an EIS sensor, an inventive electrochemical sensor operates in a nonlinear regime. By operating in this nonlinear regime, more details of the solution's electrochemistry become available, resulting in a more detailed electrochemical signature that can be used to distinguish greater varieties of phenomena, sample classes, etc., and/or to provide complementary metrics that can be tracked through time to enhance sensitivity, improve time-to-detection, and improve signal-to-noise.

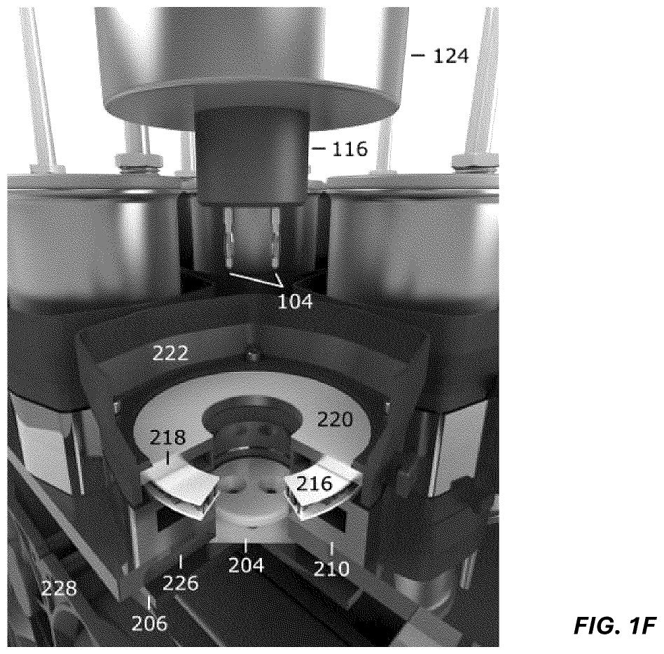

The linear electrochemical regime used in EIS is well-described by the Randles equivalent circuit shown in FIG. 5. The behavior of the Randles equivalent circuit is dominated by (a) a bulk transport resistance (R_{Ω}) opposing ions' movement through the liquid medium, and (b) a nonfaradaic double-layer capacitance (C_{d}) corresponding to electrode “charging” as ions cluster near the electrode surface in a diffuse layer in response to an applied voltage. If the DC bias voltage (V₁-V₂) is sufficiently high for electrochemical reactions to occur at the electrodes, a separate faradaic pathway opens in parallel to the double-layer capacitance. A linear treatment of faradaic reactions and specific adsorption reduces these complex phenomena to a charge-transfer resistance (R_{ct}) corresponding to the kinetics of the reaction, and a Warburg impedance (Z_{W}) corresponding to buildup of reactants and products at the electrodes. These approximations are only valid for a small-amplitude, high-frequency perturbation around a fixed DC bias voltage, and do not describe the full dynamic behavior of the system.

As suggested by the Randles equivalent circuit in FIG. 5, the impedance of an electrochemical cell can be represented as a transfer function (as gain and phase in the frequency domain), impulse response (as a weighting in the time domain at various lags), or a Nyquist plot (combining gain and phase).

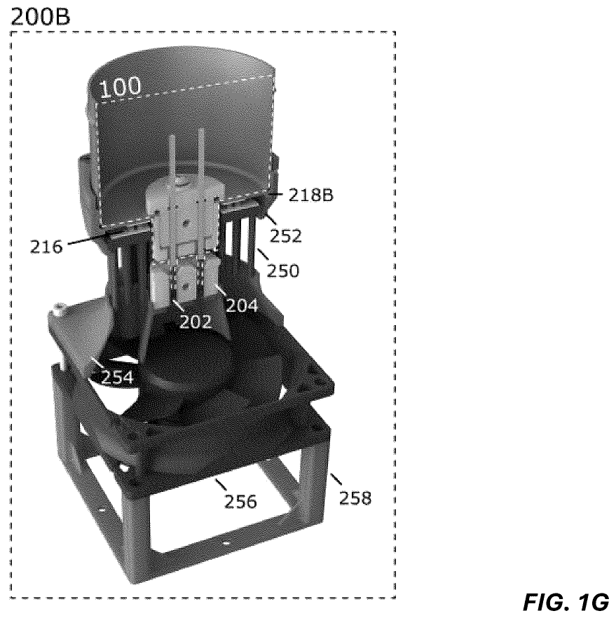

By contrast, a nonlinear electrochemical treatment incorporates the full effects of thermodynamics (governing whether the reaction occurs, equilibria, and penalties based on concentrations of different species), kinetics (governing how quickly the reaction occurs), and transport (governing the buildup of concentration gradients of products and reactants at the electrode surfaces). The difference in current-voltage behavior can be qualitatively illustrated, for a voltage sweep, in FIGS. 6A and 6B. In FIG. 6B, an onset voltage (E₀) occurs before the reaction begins to occur at nonzero rates; the reaction rate rapidly climbs due to kinetic effects as additional voltage is supplied (activation overpotential); and the reaction rate is eventually limited by transport effects (concentration overpotential and limiting current). A linear model (as in EIS) cannot capture this behavior and is instead limited to a linearized view of the same reaction for small perturbations around a DC bias voltage (E_{DC}) as shown in FIG. 6A.

Quantitatively, and for input waveforms more complicated than a steady voltage ramp, a series of equations describes electrochemical behavior, including the Nernst, Butler-Volmer, Nernst-Planck, and Koutecky-Levich equations.

In contrast to EIS, which uses only the linear regime, the present technology makes use of the nonlinear regime. The measurement electrodes and measurement electronics are modified to excite these nonlinear phenomena, and a different processor captures these phenomena in a dynamic model. EIS is typically performed using sinusoidal input signals of differing frequency and low magnitude. Nonlinear dynamics are more readily probed by stochastic signals (with a non-binary amplitude distribution) of higher amplitude—resulting in higher currents than EIS, and a greater variety of waveforms to be produced by onboard waveform generators (digital-to-analog converters and amplifiers) and recorded by onboard oscilloscopes (analog-to-digital converters).

These differences between EIS and the inventive techniques lead to differences between conventional EIS sensors and the inventive sensor. For instance, a conventional EIS sensor generates a constant DC bias voltage, then adds a small amplitude perturbation on top of it. An inventive electrochemical sensor, on the other hand, includes or uses a waveform generator that can generate waveforms with arbitrary shapes. These waveforms can fluctuate over the entire voltage range, which may be ±5 V, in just a handful of time steps, instead of fluctuating by a few millivolts around a constant value as in EIS spectroscopy.

### Comparison With Standard Nonlinear Electrochemical Techniques

There are several established electrochemical techniques to investigate nonlinear effects. Each of these uses a carefully prescribed input waveform and is significantly slower than either EIS or the inventive technology. Compared to established nonlinear measurement techniques, an inventive sensor can (1) simplify the electrochemical cell, facilitating miniaturization, and (2) analyze higher-frequency signals, facilitating faster overall measurements.

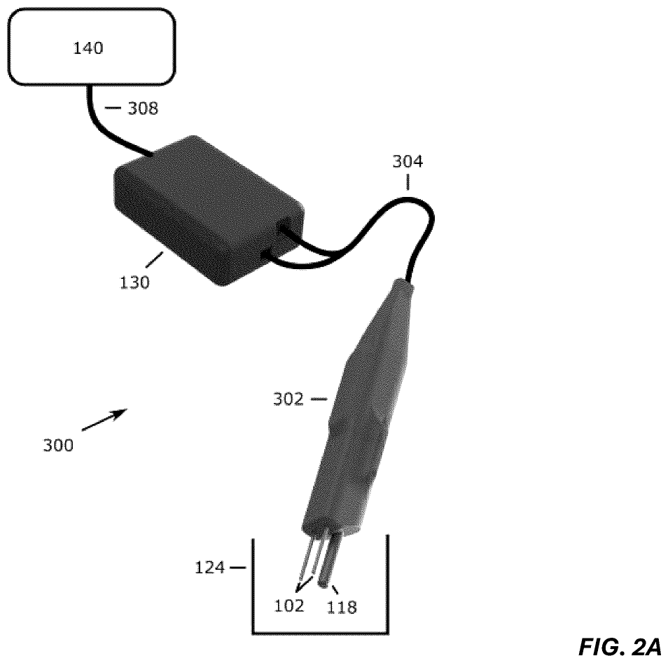

FIGS. 7A and 7B illustrate an electrochemical cell 700 and a reference electrode 730, respectively, suitable for investigating nonlinear effects using established electrochemical techniques. Unlike an inventive electrochemical sensor, the electrochemical cell 700 needs three electrodes—a reference electrode 730 in addition to a working electrode 710 and a counter electrode 720. The working electrode 710, counter electrode 720, and reference electrode 730 are coupled to a potentiostat 702, which controls voltage between the reference 730 and working 710 electrodes by driving current 704 between the counter 720 and working 710 electrodes. This isolates one half-reaction, displayed here as O1+e⁻→R1, for study. By contrast, in a two-electrode experiment, both half-reactions (and other chemistry, including bulk transport resistances) contribute to measured voltage.

FIG. 7B illustrates the working principle of the reference electrode 730, which in this case is a silver/silver chloride (Ag/AgCl) reference electrode. The reference electrode 730 includes a liquid electrolyte 731, such as potassium chloride (KCl) and 2-4% agar in water, in a glass capillary 732 whose tip is filled with a salt bridge 735, such as potassium nitrate (KNO₃) and 2% agar in water, and has a diameter at its end of 5-100 μm. The other end of the glass capillary 732 is capped with a polymer block 734 and a gold-plated connector 736. A silver wire 738 extends from the gold-plated connector 736 through the polymer block 734 into the liquid electrolyte 731, where AgCl 739 forms or is artificially deposited on its outer surface. While the details of construction vary based on reference electrode chemistry and desired application, this is representative of the elements of many reference electrodes.

As shown in FIG. 7B, the reference electrode's chemistry and lack of significant current flow ensures it remains at a well-defined reference potential. By understanding the potential of the working electrode 710 relative to the fixed reference potential 730, the processes (both non-Faradaic and Faradaic—including half-reactions) at the working electrode 710 can be studied in isolation. In this operational mode, the potentiostat 702 drives a (potentially significant) current between the counter electrode 720 and working electrode 710, controlled to maintain a specified voltage waveform between the reference electrode 730 and the working electrode 710 as shown in FIG. 7A.

Without the reference electrode 730, the voltage across the whole electrochemical cell is controlled, rather than the voltage across a single electrode half-reaction—overlaying the dynamic current-voltage behavior of the counter electrode 720 and the electrolyte 706 lying between electrodes 710 and 720 onto that of the working electrode 710. If such a two-electrode cell were used to perform standard nonlinear electrochemical measurement techniques (such as normal pulse voltammetry NPV, cyclic voltammetry CV, or alternating current AC voltammetry), the tightly controlled input waveforms would be significantly perturbed, rendering the output unusable under the traditional analysis frameworks that distinguish thermodynamic, kinetic and transport effects. The output is further perturbed as the sweep rate or measurement frequency is increased, in which case transport effects largely mask thermodynamic and kinetic effects.

However, when using inventive analytical techniques, it is possible to efficiently study thermodynamic, kinetic and transport effects in a two-electrode cell, even at high frequency. First, an inventive electrochemical sensor can operate without a reference electrode to reduce complexity, cost, and difficulty in miniaturization. Second, an inventive electrochemical sensor can perform measurements at significantly higher frequency and shorter total measurement time than standard nonlinear techniques (e.g., NPV, CV, and AC voltammetry). Both effects are made possible by the inventive electrochemical sensor's combination of measurement electronics and analysis processing.

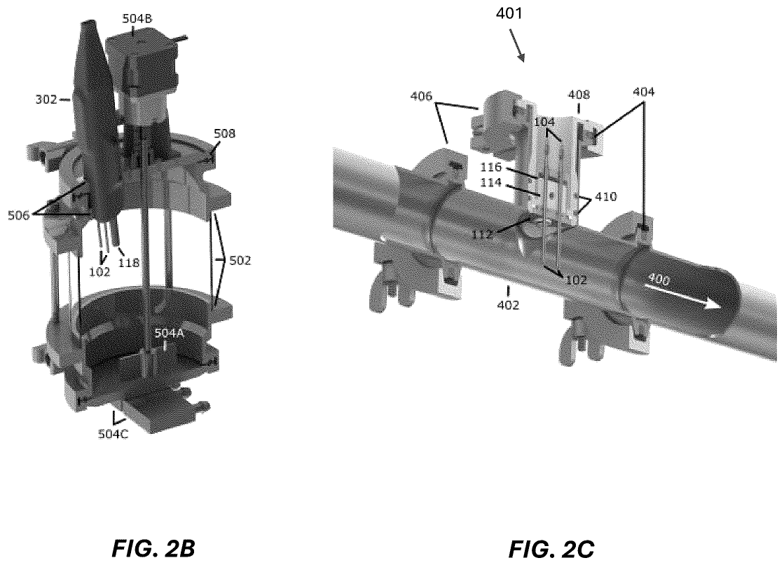

FIG. 8 illustrates three standard electrochemical techniques: normal pulse voltammetry (NPV) (left), cyclic voltammetry (CV) (center), and alternating current (AC) voltammetry (or cyclic AC voltammetry) (right). In NPV (FIG. 8, left), a series of voltage steps is applied to an electrochemical cell, and the current i flowing at a given time λ is recorded for each step. This i(λ) carries information about the thermodynamic potential of the reaction; kinetics, in the regime of rapid growth; and transport, in the limiting-current regime. In CV (FIG. 8, center), a triangle wave in voltage is applied to an electrochemical cell. For every reaction, a peak in current develops on the forward and reverse sweeps. The shape of this waveform can be related quantitatively to similar thermodynamic, kinetic, and transport properties.

The waveforms for (cyclic) AC voltammetry and EIS are similar. Each are low-amplitude sinusoids in voltage, fluctuating around a mean voltage (DC offset) that can be adjusted. In AC voltammetry (FIG. 8, right), this DC offset is sequentially adjusted in a staircase waveform, similarly to CV. At each DC bias, the gain at a given frequency is measured. This results in a peak at the half-wave potential characterizing the thermodynamics, kinetics, and transport of the reaction.

Each of these techniques requires a tightly prescribed input waveform to analytically assess predominantly static (kinetic and thermodynamic) information. While this static information is, in theory, available instantaneously (without having to wait for temporal effects to play out), dynamic temporal effects can mask purely static information, especially when the measurement signal changes rapidly. (For instance, the double layer capacitance dominates current flow through the cell at high frequency, acting like a short circuit and drowning out any signal from the faradaic branch.) Therefore, the standard techniques intentionally minimize dynamic effects by sweeping slowly and waiting for steady-state or limit-cycle conditions to develop, significantly impairing the speed at which these measurements can be performed.

By contrast, the inventive technology uses a dynamic model based on the Randles equivalent circuit and advanced computational analysis to isolate the (predominantly static) kinetic and thermodynamic nonlinearities from the (predominantly dynamic) combination of linear transport resistance and double-layer capacitance. Because of the robust dynamic model, this can take place at higher frequencies, leading to faster measurements than are possible in NPV, CV, or AC voltammetry, while still seeing through to the core kinetic and thermodynamic information that is masked by transport dynamics in standard techniques at the same frequency.

There are at least three other differences between the inventive techniques and these established techniques.

First, while AC voltammetry may use high-frequency perturbations to cut through dynamic effects to similar static information, the DC bias voltage can only progress to the next step after several of these high-frequency cycles have passed, allowing the system to reach a steady state at a given bias voltage. Furthermore, if multiple frequencies are to be studied, this process must be repeated at each frequency of interest. By comparison, the inventive technique can vary the full amplitude of the signal at high frequency, can include multiple frequencies for simultaneous analysis, does not need to wait for steady state or limit cycles, and is only limited in total measurement time by fundamental principles of signal analysis (e.g., that the total measurement time should exceed the inverse of the desired frequency resolution).

Second, in the case of systems with coupled or multi-step reactions, the buildup of chemical species can result in more complex dynamic nonlinearities, beyond the simple picture of static thermodynamic and kinetic effects. These dynamic nonlinearities can be analyzed with the inventive technology using the same or similar frameworks as described for single-reaction systems. When such systems are analyzed, temporal separation still tends to spontaneously develop between fast, predominantly linear dynamics related to non-faradaic transport and slow, predominantly nonlinear dynamics related to faradaic reactions.

Third, while each of the standard nonlinear electrochemical measurement techniques typically requires a three-electrode electrochemical cell 700, similar principles could be applied in a two-electrode cell. However, simply applying standard principles in a two-electrode cell would invalidate or significantly complicate standard analytical equations used in the analysis of these techniques. Furthermore, simply removing the reference electrode would not accelerate the slow measurements characteristic of NPV, CV, AC voltammetry, and similar techniques. The benefits of an inventive sensor include both (1) acquiring usable information from a nonlinear electrochemical system without a reference electrode, enabling miniaturization that itself can modestly accelerate measurements, and (2) doing so with a stochastic waveform rather than a tightly prescribed mathematical function and analytical tools, which overcomes fundamental speed limitations imposed on standard measurement techniques. Both advantages arise together from the inventive sensor's analysis methods (and supporting measurement electronics).

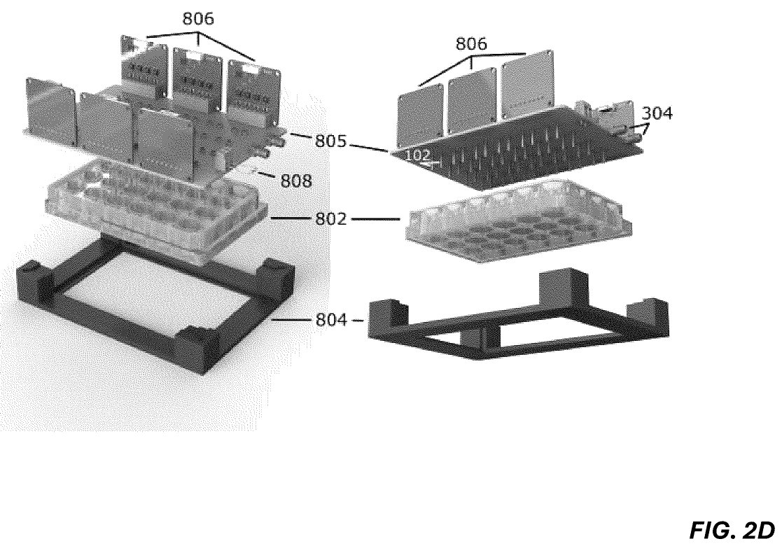

Fourth, the inventive technique uses a different input waveform than NPV, CV, or AC voltammetry. While it is sometimes desirable to model linear and nonlinear systems using separate signals (to improve the quality or change the frequency range of the linear model), it is usually generally possible to model both from the signal used to characterize the nonlinear system. Using inventive methods, it is therefore possible to collect one dataset to simultaneously construct a linear dynamic model and a predominantly static (or slowly dynamic) nonlinear model. To create this nonlinear model, an inventive electrochemical sensor uses a comparatively high-frequency, broadband (e.g., about 1 Hz to about 1 MHz or a band in that range, including 100 Hz to 10 kHz) stochastic input signal: high-amplitude (e.g., ±5 V) noise, which may be Gaussian in amplitude and white in frequency distribution (but may be any non-binary stochastic signal with any shaping of power spectral density), as shown in FIG. 9. This renders the inventive measurement technique more robust against distortions in input waveform, allows more complete modeling of dynamic effects, permits full modeling of the Randles circuit as in EIS, and additionally allows access to nonlinear information as in NPV, CV, and AC voltammetry.

An inventive sensor thereby combines the best of both worlds, mirroring the speed and versatility of EIS while accessing nonlinear information as in NPV, CV, and AC voltammetry, via the combination of (1) stochastic input waveforms, and (2) dynamic system modeling that reveals nonlinearity in electrochemical systems.

### Nonlinear Dynamic Modeling Framework

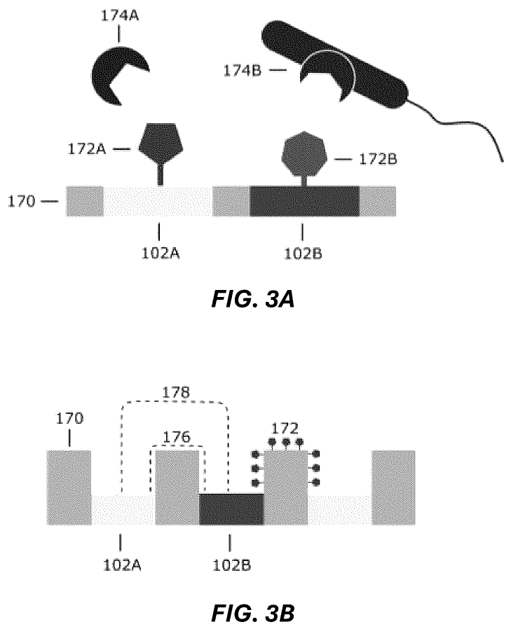

FIG. 10 shows a measurement and modeling equivalent circuit used by an inventive electrochemical sensor. A Gaussian stochastic voltage signal is provided at V₁. Both voltages V₁ and V₂ are measured by an onboard oscilloscope (measurement electronics); explicitly measuring V₁ captures any distortions in the intended waveform. The current is determined from the voltage drop across a reference resistor: i(t)=V₂(t)/R_{ref}. The voltage drop across the electrochemical cell is ΔV(t)=V₁(t)−V₂(t).

In aqueous environments, the dominant signal when a sufficient voltage ΔV is applied is typically the oxygen evolution (and oxygen reduction) reaction, in which water is split (formed) to give off (consume) oxygen gas. This occurs at ±1.23 V across the cell, so the measurement electronics of an inventive sensor are designed to appreciably exceed this threshold. The pH of the liquid sample can shift this equilibrium voltage (as can the production or consumption of gas in the liquid medium), and surface conditions at the electrodes can control the kinetic exchange current density by formation of oxides, biofilms, gels or other precipitated matter on or near the surface. Additional reactions may occur on a sample-dependent basis (e.g., an aqueous solution of chloride salts can produce chlorine gas in addition to oxygen, while non-aqueous solvents may produce entirely different reactions.) Transport of products and reactants to and from the electrodes also affects reaction rates and may be impacted by changes in mass diffusivity in the bulk medium. Thus, there are multiple characteristics in the nonlinear electrochemical regime that can be related back to microbial growth (e.g., reduction in pH under the action of lactic acid bacteria, the curdling of milk when pH is reduced to 4.5 or below, the consumption of dissolved oxygen by aerobic life forms, or the production of dissolved oxygen by photosynthesizing microbiota.)

Unlike other electrochemical sensing techniques, the inventive technology uses stochastic (typically Gaussian white noise) nonlinear system identification in a two-probe electrochemical cell to monitor microbial growth in liquid samples. This represents a powerful method of extracting thermodynamic, kinetic, and transport effects in a dynamic measurement from an electrochemical cell, hauling more information out of the system more quickly than any other two-probe technique for the development of electrochemical signatures (fingerprints) that correlate to microbial growth. This is accomplished using a unique set of modeling tools, described in the next section.

The use of a stochastic noise input signal (in an embodiment, Gaussian white noise low-pass filtered at 1/10^{th} the sampling frequency using a sixth-order Butterworth filter) enables fast dynamic measurements, and places special requirements upon measurement hardware. Beyond containing broad-spectrum frequency content (in contrast to swept sine measurements) and thereby accelerating characterization of linear dynamic systems by characterizing many frequencies simultaneously, a Gaussian (or at least non-binary) amplitude distribution can be used to assess nonlinear effects. The waveform generator of an inventive sensor (e.g., measurement electronics 130 in FIG. 1A) can produce this complex waveform at typical frequencies up to 1 MHz, peak voltages of typically ±5 V (depending on the liquid medium), and peak currents of typically ±25 mA (depending on the electrode material and sample composition). In some embodiments, the use of digital signal generation and filtering coupled with a digital-to-analog converter inside the waveform generator (e.g., sending data from a processor 140 to a waveform generator 132 in FIG. 1A) simplifies the measurement electronics circuit significantly compared to a fully analog signal generator, while also enabling arbitrary waveform generation.

The analysis of the nonlinear electrochemical dynamic systems as probed by a Gaussian stochastic input signal is significantly different from that used in EIS or traditional nonlinear electrochemical measurements. The analysis processes are described in greater detail below. They may be performed by an onboard microcontroller (e.g., processor 140 in FIG. 1A) or by an attached computer. Each modeling process yields additional parameters that describe the electrochemical system more completely than the linearized Randles equivalent circuit used in EIS—potentially capturing the thermodynamics, kinetics, and transport phenomena associated with each of several chemical reactions.

Computational requirements are mild for contemporary hardware. It is possible to perform this analysis on a modern personal computer (as has been demonstrated in physical embodiments and data collection). When generating dynamic models, graphics processing units (GPUs) can improve performance significantly for the Volterra model, whereas the Randles-inspired model is relatively lightweight and central processing unit (CPU)-viable. This makes the Randles-inspired model potentially adaptable to microcontrollers and low-cost hardware.

An inventive electrochemical sensor also measures temperature or is coupled to a temperature sensor (e.g., temperature sensor 118 in FIG. 1A, which could be a thermocouple, RTD, thermistor, or non-contact device) because many electrochemical parameters (including R_{Ω}, C_{d}, the thermodynamic equilibrium potential, the kinetic exchange current density, and the transport limiting current) vary strongly with temperature. In practical use, a library of electrochemical fingerprints can be established in a given medium at various fixed temperatures. An inventive electrochemical sensor may then simply read the temperature and compare the electrochemical fingerprint to the library's database at that temperature. Control of the sample temperature is optional.

### Inventive Modeling and Data Analysis

The inventive technology can perform or include two levels of analysis. The first creates dynamic system models from input-output data. The second traces the parameters or characteristics of these models as they evolve over time. At least one, and typically both, are performed by an inventive processor.

### System Modeling Methods

For each measurement (composed of, for instance, tens of thousands to millions of input-output data point pairs), the system is analyzed via an extension of the Randles equivalent circuit shown in FIG. 10. The double-layer capacitance is replaced by a generic linear dynamic clement H(s), which is described by a transfer function (frequency domain) or impulse response (time domain). In parallel, there is a generic nonlinear dynamic element N(s). These approximate the roles of the double-layer and the Faradaic reactions in a gray-box approach (a physics-inspired model structure with black-box elements).

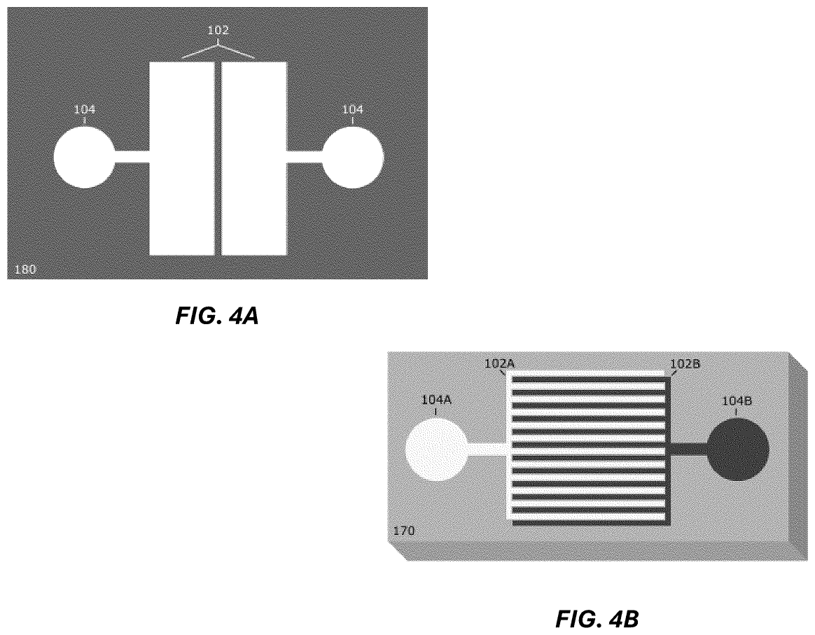

FIGS. 11A and 11B show two inventive modeling methods that can represent this electrochemical system: a Randles-inspired model (FIG. 11A) and a Volterra-based model (FIG. 11B). In both modeling methods, the bulk transport resistance R_{Ω} is first estimated from the high-frequency response in a purely linear Randles equivalent circuit view, above the cutoff frequency for capacitive responses. At sufficiently high frequency (typically 1 MHz in the preferred embodiments), very low voltage is dropped over C_{d} and essentially all current flows through this double-layer capacitance, short-circuiting the Faradaic branch. As the voltage ΔV′(t) shared by these two parallel branches drops, the Faradaic reactions “turn off” due to insufficient driving potential, reinforcing this effect and providing a highly linear system. Therefore, at high frequency, the electrochemical system behaves essentially as a resistor, yielding R_{Ω}. Both modeling approaches then view the system with an output of i(t) and an input of ΔV′(t)=ΔV(t)−i(t)R_{Ω}: solely the voltage drop shared by the two parallel branches of H(s) and N(s).

This framework may be used regardless of whether a controlled current or controlled voltage is imposed across the electrodes during a measurement. Equivalent inventive frameworks are also possible in which the roles of i(t) and ΔV′(t) are swapped, or a different definition of ΔV′(t) is used to fill a similar role.

### System Model 1: Randles-Inspired (Gray-Box) Method

In the first inventive modeling approach, H(s) is trained first, separately from N(s), using linear stochastic system identification, resulting in a linear model current prediction iₐ(t) that differs from i(t). The nonlinear element N(s) is then taken to comprise the system that produces i_{b}(t)=i(t)−iₐ(t) under the stimulus of ΔV′(t), encompassing the residual current which is not explained by H(s). The residuals may be modeled explicitly (e.g., by curve fitting a cross-plot of ΔV′(t) and i_{b}(t), in cases where a simple curve fit is possible, indicating a static nonlinearity), or analyzed in statistical aggregate (e.g., by quantifying the distribution of i_{b}(ΔV′), which is of particular use when dynamic nonlinearities exist). Details of the signal processing involved are described in greater detail below. This is referred to below as a Randles-inspired approach for its physical basis in the Randles equivalent circuit.

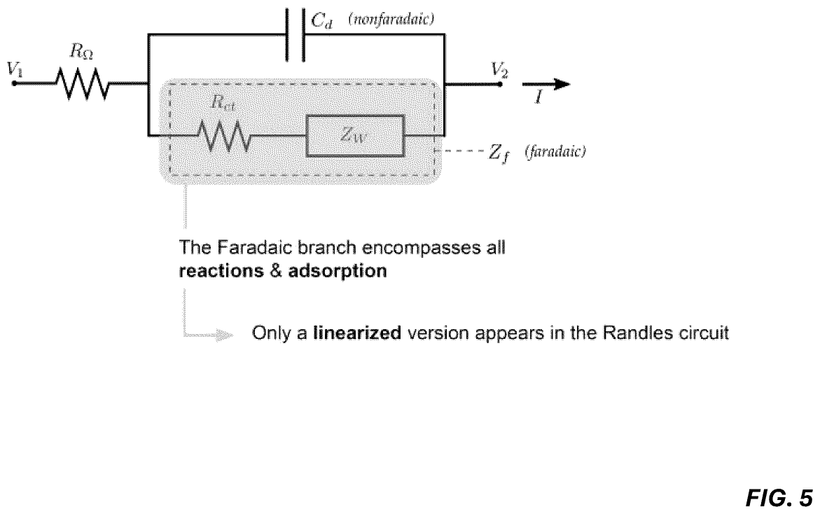

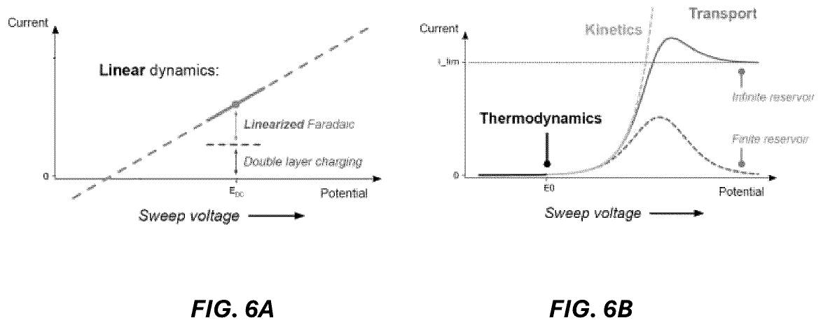

FIGS. 12 and 13 illustrate the utility of this model. FIG. 12 compares a standard Wiener model (of ΔV as a function of i, where, as shown in FIG. 13, the static nonlinearity is plotted as ΔV vs. the internal signal u) to a Randles-inspired voltammogram of N(s) (ΔV′ vs. i_{b}) at 1 kHz. The Randles-inspired model is significantly more effective at revealing nonlinear behavior when the nonlinearity i_{b} accounts for a small portion of the overall current i(t)—as is the case at high frequencies, when most current flows through H(s). A similar clarity of nonlinear features is only available in traditional voltammograms (Wiener systems of ΔV vs. i) at 1 Hz—three orders of magnitude slower (FIG. 13). This Randles-inspired method enables fast measurements of electrochemical nonlinearity at comparatively high frequency.

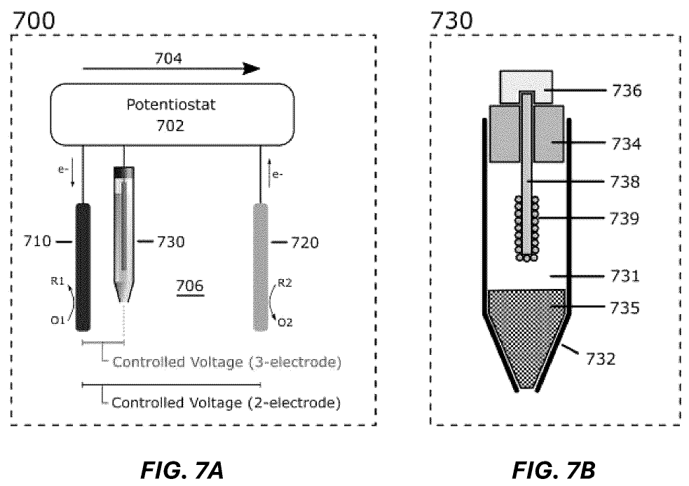

For simple forms of the nonlinearity N(s) that appear quasi-static (reactions without appreciable transport dynamics), it is possible to fit a static curve through the plot of i_{b}(ΔV′). This has been demonstrated in a system of aqueous 0.02 M Na₂SO₄ with only 2 to 4 parameters, using cubic and tri-linear functional forms as shown in FIGS. 14A and 14B. Curve fitting in this manner is both a modeling method and a method of extracting parameters from the Randles-inspired model.

A variation of the Randles-inspired method is to treat N(s) as a static nonlinearity n(ΔV′), and to model H(s) and n iteratively as a parallel L-N model, in a manner similar to Wiener models, rather than identifying H(s) only once.

In the Randles-inspired method, H(s) experiences some effects of Bussgang's theorem: the H(s) element attempts to capture all system dynamics, whether linear or nonlinear in nature, using only a linear system. This causes two complications, (a) and (b). In complication (a), if H(s) and N(s) are iteratively or simultaneously optimized, portions of the signal initially accounted for by H(s) can migrate to N(s), resulting in poor convergence of the optimizer. It is therefore helpful to either fix H(s) when optimizing a model for N(s), or to place constraints on N(s) that prevent drift in H(s), such as enforcing zero slope in i_{b}(ΔV′) at ΔV′=0. In complication (b), by Bussgang's theorem, if the nonlinearity is static and the input signal is Gaussian, a model for H(s) can be uniquely determined despite the presence of N(s). However, if the nonlinearity is dynamic, artifacts from the nonlinear system can enter H(s), which (in contrast to a true linear system) can change depending on input signal amplitude. A consistent representation of N(s) and H(s) can still be extracted, with proper conditioning, so long as the input signal amplitude and frequency characteristics are held constant across each measurement.

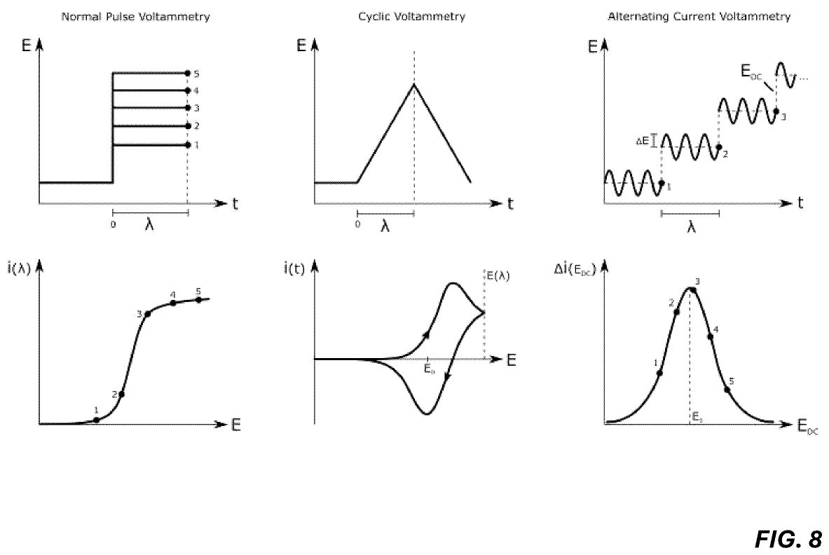

R_{Ω} generally makes a significant impact in identification of the system model. Accurate identification of R_{Ω} (FIG. 15) sometimes involves smoothing operations based on the local neighborhood of measurements. However, depending on the sample, R_{Ω} may constitute a more or less important contribution. If identifying R_{Ω} is abridged or omitted, the inventive Randles-inspired method can still be meaningfully employed.

### System Model 2: Volterra Series Method

In the second modeling method, H(s) and N(s) are trained simultaneously. This can be achieved through a Volterra series model structure and provides an explicit dynamic model estimate for N(s).

Any nonlinear dynamic system has a Volterra series representation, just as any static function has a Taylor series representation. The Volterra series expansion is composed of convolutions of a memory vector x with kernels hᵢ. When predicting an output data point y(t₀) using memory length m, the memory vector comprises the last m samples of the input x prior to t₀. Each Volterra kernel hᵢ is a tensor of order i:h₀ is a scalar; h₁ is a vector corresponding to the impulse response function; and h₂ is a matrix corresponding to the first nonlinear terms (e.g., xⱼxₖ or xⱼ²). The series expansion can be carried out to arbitrarily high order i, but is typically truncated at i=2 due to the growing number of model parameters (each additional kernel hᵢ adds up to mⁱ new model parameters). The predicted output y is composed as y=h₀+convolution(h₁, x)+convolution (h₂, x, x). Sparsity schemes can make higher order kernels feasible, in which case each additional kernel contributes one further term in the preceding equation.

A Volterra series truncated at i=2 may be used to identify estimates for H(s) and N(s) simultaneously. The linear dynamic element H(s) is represented by the h₁ kernel, while N(s) is represented by the h₂ kernel. Typically, the zero-order kernel h₀=0, so the second-order Volterra expansion reduces to the parallel H(s) and N(s) branches of FIG. 10. Currents predicted by each kernel (iₐ and i_{b} from h₁ and h₂) add together to produce the overall current prediction, as in the Randles-inspired model. This permits better separation of linear and nonlinear model effects, while retaining the equivalent circuit of FIG. 10. Kernels beyond h₂ would contribute additional branches that can be conceptually grouped with h₂ as N(s).

FIG. 11B shows an example h₂ kernel. In the Volterra approach, R_{Ω} may be considered separately, as in the Randles-inspired approach, or incorporated into the Volterra system as a fully black-box model. Various schemes may also be imposed on the h₂ kernel (and higher-order kernels) to reduce the number of independent model parameters. The Volterra model may also be derived from a more concise model, such as a NARMAX (Nonlinear AutoRegressive Moving Average with exogenous inputs) model, to reduce the number of independent model parameters during optimization.

### Tracking Model Parameters Over Time

Over longer time scales, the parameters and characteristics of the above models may change. Several different methods may be used to track changes in these dynamic models over time, including principal component analysis (PCA) for characterization of changes in H(s), and the method of envelopes for characterization of changes in N(s). These methods address the problem of using a small (typically less than 10) set of latent variables to describe coordinated changes across large numbers of discrete-time model parameters (typically hundreds, in the case of transfer functions H(s), or thousands, in the case of Volterra h₂ kernels and the Randles-inspired dynamic nonlinearity N(s)).

### Tracking Method 1: Direct Monitoring of Model Parameters

In the case of relatively parsimonious models (those with less than 10 parameters), an inventive sensor can monitor the model parameters directly.

In EIS, it is possible to extract R_{Ω}, R_{ct}, C_{d} and other parameters. In the linear dynamic portions of the Randles-inspired and Volterra models (H(s) and h₁), it is possible to extract similar parameters. The bulk transport resistance R_{Ω}, as used in the Randles-inspired model, has been confirmed to be useful as such a metric as shown in FIG. 15.

This is also possible in simple nonlinear cases. In the curve-fit parameterizations of N(s) in the Randles-inspired model and the static nonlinearity in the Wiener model (FIG. 14A), it is feasible to individually track the (typically two to four) curve-fitting parameters to monitor microbial growth.

In more complex nonlinear models, it may be feasible to track a subset of prominent model parameters directly, but typically an aggregation method is required to monitor simultaneous variations across many closely related model parameters. Two inventive aggregation methods are described below.

### Tracking Method 2: Method of Envelopes

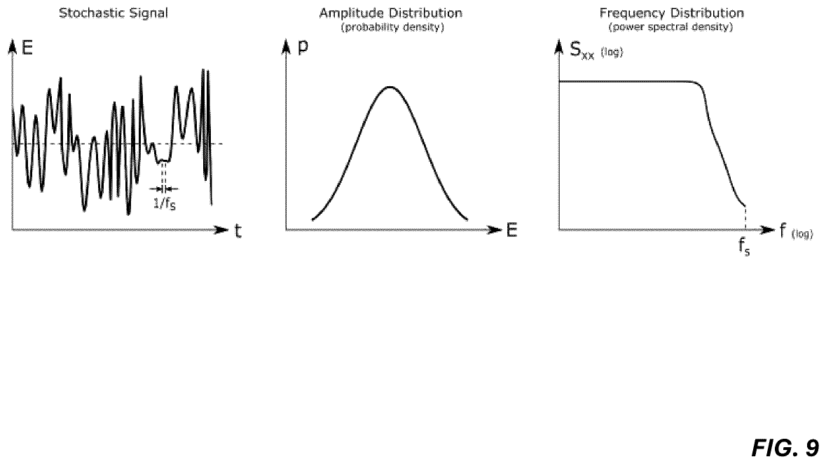

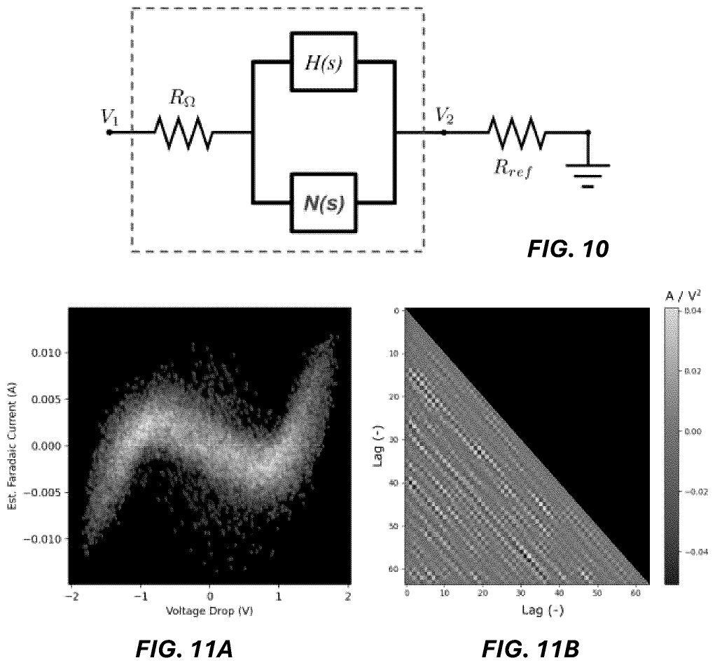

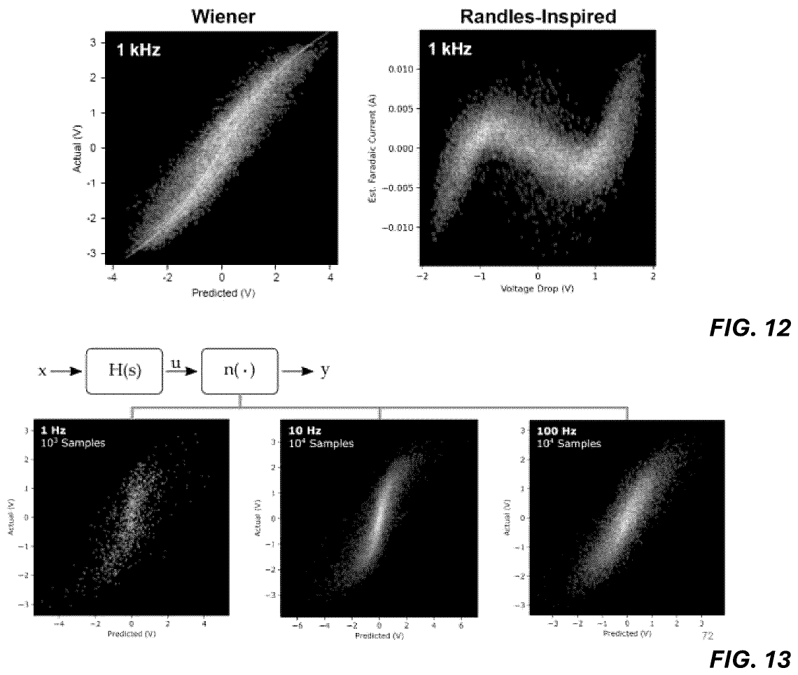

The 2D information represented by plots of N(s) in the Randles-inspired model in cases where the electrochemical nonlinearity is not quasi-static cannot be well-described by a curve fit (FIGS. 16 and 17). Instead, to extract model parameters, N(s) can be split into halves along the i_{b}=0 axis and collapsed to 1D information by the weighted average Σᵢ_{_{b}}₌₀^{∞}(ρ(i_{b}, ΔV′). i_{b}) for bins in i_{b} and ΔV′ (FIG. 18). Here, ρ is the local density of data points at a given i_{b} and ΔV′. Variations on this formula serving a similar purpose are possible.

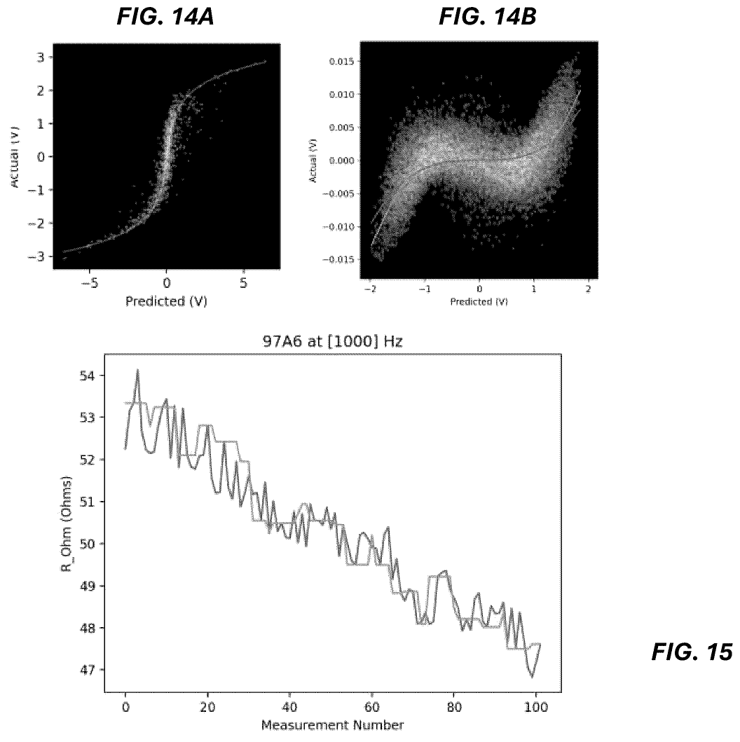

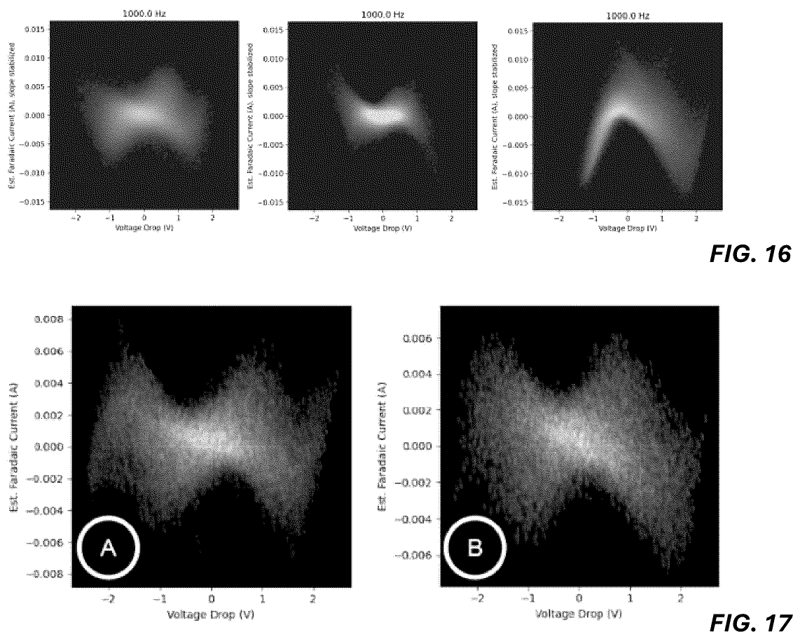

This results in an “envelope” that traces the boundaries of N(s). These envelopes are observed to change over time in response to microbial growth (FIG. 19). The envelopes can, for instance, either be fit as a series of Gaussian peaks (FIG. 18) or identified by their local extrema (FIG. 19). In either case, in aqueous media, this provides 8 to 12 parameters that form an electrochemical fingerprint for the sample. An inventive sensor can generate and track this fingerprint as it evolves over time (FIG. 20).

The exact shape of these envelopes can change depending on the range of the applied voltage ΔV′, the nature of the sample medium, the catalytic properties of the electrodes, and other properties. This may alter the functional form suitable for curve fitting of the envelope, change the number of meaningful parameters that can be extracted as latent variables, and result in the creation or disappearance of local extrema. However, similar envelopes can still be generated, parameterized, and tracked over time by an inventive sensor.

### Tracking Method 3: Principal Component Analysis

Principal component analysis (PCA) is a widely used blind signal separation technique (equivalently, a dimensionality reduction technique or form of compression or denoising) that identifies the latent variables driving most of the statistical variance in a set of n-dimensional data points.

As used in an inventive sensor, each data point can represent the parameters that define one portion of the inventive dynamic model (e.g., H(s), N(s), or h₂). As the model changes systematically over time under the influence of microbial growth, the latent variables serve as a concise summary of changes to the dynamic model and can be used to track microbial growth in a given sample and/or to correct for temperature.

PCA produces an orthonormal coordinate basis in the measurement space (here, Rⁿ, where n is the number of model parameters), with basis vectors ordered by explanatory power over the training data (the most important vectors appearing first). A data point in the model space (representing one dynamic model) can then be transformed into this principal component space via a transformation matrix, encoding the model's parameters as a set of principal component scores (the latent variables). Because the basis vectors are ordered by explanatory power, most of the latent variables can be discarded beyond the first handful, taking with them most of the system's noise.

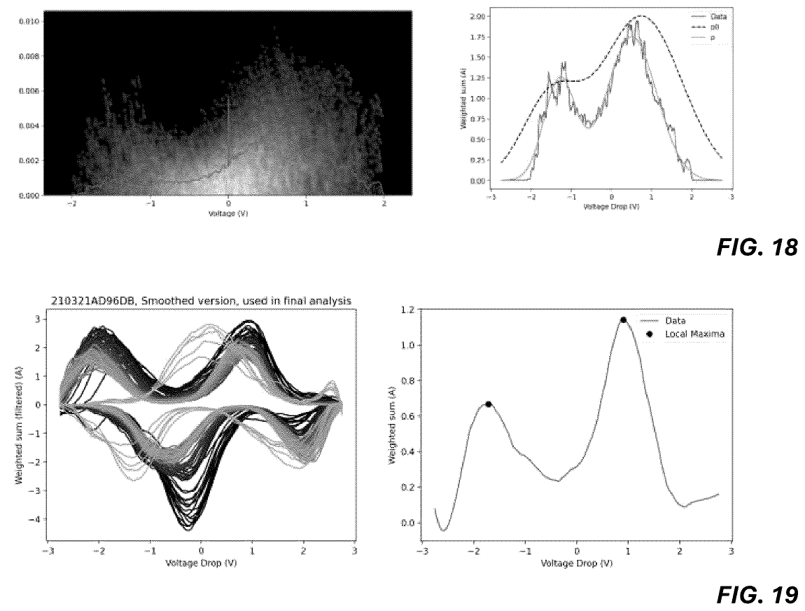

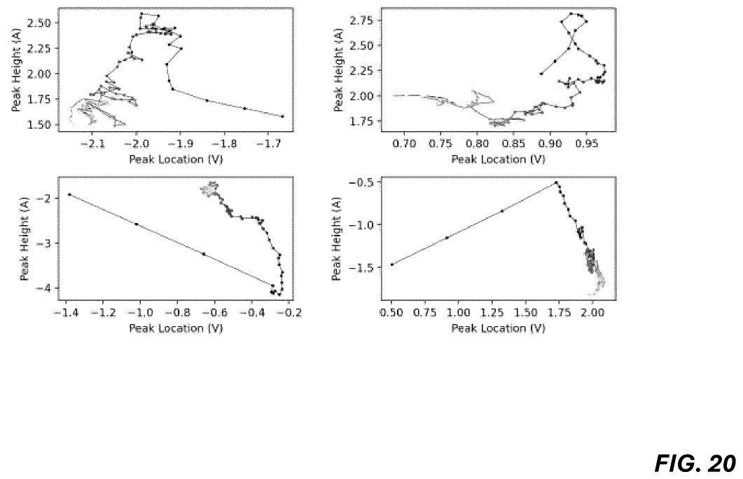

PCA is well-suited to describe changes to the linear electrochemical dynamics (FIGS. 21 and 22). Capturing the evolution of these linear dynamic elements is part of the process of capturing N(s) in the Randles-inspired model.

PCA can also be used to describe shifts in the behavior of nonlinear dynamic models.

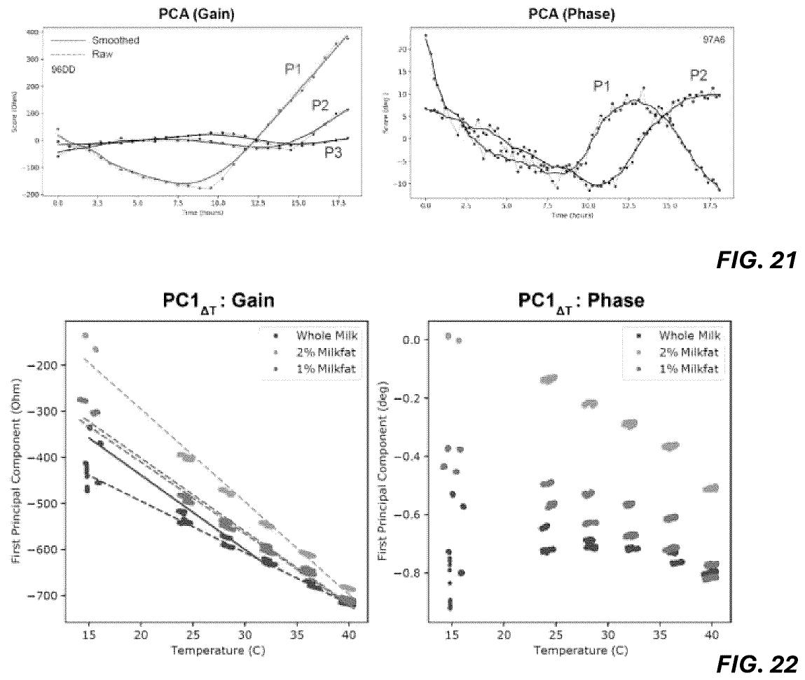

In the case of the Randles-inspired model, when N(s) is simplified to the envelope representation of the preceding subsection, changes in this envelope can be represented via PCA, treating each point on the envelope as a model parameter. This is illustrated in FIG. 23.

PCA may also be applied to the h₂ kernel for Volterra models in a method analogous to that for H(s) or for N(s) envelopes by first flattening the elements of the h₂ kernel into a vector.

PCA is one of many dimensionality reduction techniques commonly employed to analyze high-dimensional data. Variations on this inventive method are possible using other dimensionality reduction techniques in an inventive sensor.

### Neural Ordinary Differential Equations

In any of the preceding three cases, with a sufficiently large library of electrochemical fingerprints which evolve over time, it may be possible to form a predictive method that estimates likely trajectories of fingerprints over time. This may take the form of a neural ordinary differential equation, which has been demonstrated on linear (H(s)) PCA data for milk as part of the present technology. Other similar machine learning structures are also possible for the prediction of parameter evolution, as are extensions to prediction of the parameters of nonlinear models.

### Inventive Electrochemical Sensors

### Simplified Electronics & Time Savings

Measurements based on traditional structured signals (e.g., triangle waves, square waves, DC-biased sinusoids for cyclic voltammetry, square wave voltammetry, and AC voltammetry) take many repetitions to reach steady-state limit cycles, upon which each repetition of the input signal gives the same output signal. Each of the first several cycles is different, before the output settles into a pattern.

This is the result of the buildup of products and reactants into concentration gradients near the surface of the electrodes, as well as the evolution (or consumption) of gascous products that slowly saturate the liquid or form bubbles before escaping. Namely, NPV, CV, and AC voltammetry each include significant contributions from mass transport effects near the electrode surface. Traditional analysis techniques incorporate these transport effects and rely on them for analytical descriptions of output waveforms from which electrochemical information can then be extracted. These mathematical descriptions are only valid after the limit cycles have converged, thus placing a waiting time before meaningful data can be acquired. This is especially notable in the ubiquitous cyclic voltammetry.

Stochastic system identification, however, does not require a stable limit cycle or analytical descriptions of electrochemical waveforms under tightly controlled input signals. Use of a dynamic model to represent input-output (here, current-voltage) relationships renders the technique insensitive to the exact waveforms used for input or acquired as output.

Distortions from electrochemical cell architecture (as in the use of a two-electrode cell where individual electrode voltages cannot be isolated) or measurement electronics (as in imperfectly linear amplifiers or visibly discretized digital-to-analog converters), and non-repeating input signals, are also tolerable without affecting the mathematical model for the electrochemical system. This allows for simplifications in measurement electronics in comparison to other nonlinear electrochemical techniques.

This enables the inventive technology to provide a uniquely rapid method of probing electrochemical thermodynamics and kinetics in a liquid medium without the need to wait for mass transport effects to develop into a steady limit cycle.

This is a characteristic of the measurement electronics (signal generation and acquisition), sensor construction, and analysis methodology used in an inventive sensor and is not easily replicated by existing sensors.

### Additional Use Cases

The inventive technology can be used for applications other than monitoring microbial growth. For example, the present technology can be used to monitor machine oil for degradation at high temperature (a non-biological process); to discern the presence and concentrations of multiple components in a product (more than the 2 to 3 that would be permitted with EIS alone based on the number of parameters extracted for the Randles equivalent circuit—e.g., protein, sugar, and fat levels in milk, in addition to microbial population and various additives); to monitor phase separation in liquid media; or to monitor the products of bioreactors, e.g., thickness of cellulose pellicles.

### Applied Current

The applied Gaussian stochastic signal may be either a current or a voltage waveform. Applying a current better maintains the Gaussian nature of the input using what is otherwise the same hardware and software. (Since the applied voltage is divided across the electrochemical cell and the reference resistor, normally only V₁ is Gaussian—not ΔV. However, both elements share the same current, which will remain Gaussian if it is supplied as Gaussian.)

### Other Stochastic Signals

Stochastic signals of non-Gaussian amplitude distribution and non-white frequency distribution may also be used in an inventive sensor, so long as the amplitude distribution is non-binary. In frequency, a shaped power spectral density may be used to deliver additional power at frequencies of interest, while in amplitude, a non-Gaussian probability density can be used to spend more or less time in Faradaic regimes, further from the mean at zero. A non-zero mean can be used to investigate asymmetry in electrochemical behavior at the two electrodes, particularly if their surfaces differ catalytically or in other near-surface properties.

### Additional Electrode(s)

It is possible to add a reference electrode to an inventive two-electrode sensor to create a three-electrode sensor. Doing so creates an electronic fingerprint at each electrode, rather than only one for the whole electrochemical cell. Similarly, additional pairs of electrodes of dissimilar materials may be introduced, to create more than one fingerprint per sample, based on each electrode having different electrocatalytic properties.

### Auxiliary Reference Circuits

Auxiliary circuits may be used to perform a partial or complete analog analysis to aid in system modeling (for example, by constructing a physical embodiment of the Randles equivalent circuit and taking the difference between the output of this and the real electrochemical cell). The auxiliary circuits may be pre-tuned to closely match the behavior of the electrochemical cell, or contain tunable elements.

### Temperature Excursions

Temperature excursions may be intentionally induced to distinguish sample behavior by the temperature dependence of model parameters. This has been demonstrated using the present technology to distinguish between different milkfat grades, using linear PCA parameters.

### Continuous Measurements

Finer and lower-noise measurements may be made by generating a continuous (arbitrary-length) stochastic signal input and recording a continuous (arbitrary-length) output. In the preferred embodiments above, only finite-length signals are generated and recorded. Each finite-length input-output response is considered one “measurement”. This makes sense for systems that evolve very slowly in time in comparison to the measurement duration, so that empty space exists between measurements. However, this is not required. Using the same hardware and very similar software, an inventive sensor can perform arbitrary-length signal generation and recording by use of software buffers. From this arbitrarily long dataset (length M), a subset of given length L<M may then be chosen as a measurement, and the analysis of the inventive methods performed. The subset defining the measurement may then be shifted to a point later in time, resulting in a second measurement. However, these two measurements need not be offset by L samples (as is the case in the finite-length input-output systems.) Instead, the subset for the second measurement may be offset by as little as 1 data point. This means that a total of M−L measurements can be made from a dataset of length M. If the same dataset were treated as physically distinct measurements each of length L, with no overlap, only M/L measurements could be made. At very high M, this approaches a factor of L difference between the number of measurements available to the two approaches. In the preferred embodiment, L varies from 10⁴ samples to 10⁶ samples, so this difference is significant. These highly redundant models permit greater filtering of results, promoting a dramatic reduction in noise arising from random variations in the modeling process.

### Other Modeling Methods

Additional modeling methods may reasonably be used to identify the linear and nonlinear elements H(s) and N(s) other than the two embodiments above. Similarly, the location of R_{Ω}, arrangement of parallel or series branches, and presence or absence of explicit C_{d}, R_{ct}, and Z_{w} are minor variations. It may also be possible to create hybrids of the present technology with existing electrochemical techniques, including CV, NPV, and AC voltammetry. These variations may be produced using similar hardware (sensor head and measurement electronics) and software for the same application (monitoring microbial growth) while incorporating these minor differences in modeling.

### Virtual Experiments

An inventive sensor can, with a sufficiently advanced black-box or gray-box model, simulate the electrochemical system's response to more traditional measurement waveforms (those used in CV, NPV, and AC voltammetry), and thereby extract fundamental electrochemical parameters from an inventive black-box or gray-box model using traditional analysis methods.

### Sensor Head Design

One aspect of the inventive sensor is low-cost sensor head technology. These sensor heads may be plugged into external measurement electronics as interchangeable parts, or integrated into a single package with the measurement electronics, depending on the application. The options include (1) a permanently affixed sensor head; (2) a removable sensor head, which may be sanitized chemically or by autoclave, and replaced when permanently degraded; or (3) a disposable sensor head, either for integration into packaging, or as a stand-alone sampling card.

### Computation

The computer that controls the measurements, creates dynamic models, and tracks model parameters over time may be packaged with the inventive sensor or may be separate. An embodiment of the inventive sensor may include custom-built computational hardware, or may rely on existing consumer PCs (for single users or small laboratories), micro-PCs (e.g., Raspberry Pis, for larger low-cost networks or educational facilities), microcontrollers, or industrial control computers (e.g., a programmable logic controller (PLC)).

### Networking

Depending on the application, different combinations of sensor heads, measurement electronics, and processors may be employed in an inventive sensor network based on the inventive sensor. The simplest case is of one sensing head, coupled to one measurement unit, coupled to one processor. However, multiple sensing heads can also be multiplexed onto a single measurement unit, either for sequential measurements or for single-input multi-output schemes. Groupings of either of the above cases may also be connected to a single computer (processor). In large facilities, multiple processors may communicate with each other to establish a facility-wide sensing network. The different network architectures described above may be leveraged to conserve computational resources (to power the most advanced analysis techniques described in this text, particularly methods based on the Volterra series) or to conserve measurement electronics (in cases where these become a dominating factor in cost or physical footprint of the system, or when downtime between measurements permits sharing of measurement electronics).

### Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including clements other than B); in another embodiment, to at least one, optionally including more than one, B, with no A present (and optionally including clements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An electrochemical sensor comprising:
a signal generator to generate a stochastic waveform;
a pair of electrodes, in electrical communication with the signal generator, to apply the stochastic waveform to a liquid;
measurement electronics, operably coupled to the pair of electrodes, to measure current flowing through the liquid between the pair of electrodes and/or voltage across the pair of electrodes in response to the stochastic waveform; and
a processor, in electrical communication with the pair of electrodes, to create a dynamic model characterizing a relationship between the current and/or voltage and the stochastic waveform in the liquid and to estimate changes in electrochemical properties of the liquid based on changes in parameters of the dynamic model.

2. The electrochemical sensor of claim 1, wherein the signal generator is configured to generate the stochastic waveform with an amplitude greater than an amplitude at which Faradaic reactions and specific adsorption occur in the liquid.

3. The electrochemical sensor of claim 1, wherein the signal generator is configured to generate the stochastic waveform with a bandwidth spanning from about 1 Hz to about 1 MHz.

4. The electrochemical sensor of claim 1, wherein the pair of electrodes is functionalized to enhance sensitivity to and/or selectivity for a species in the liquid and/or textured to distinguish between near-surface and bulk current pathways in the liquid.

5. The electrochemical sensor of claim 1, wherein the dynamic model comprises a linear dynamic element and a nonlinear dynamic element.

6. The electrochemical sensor of claim 1, wherein the processor is configured to estimate a set of latent variables that describe changes to the parameters of the dynamic model.

7. The electrochemical sensor of claim 6, wherein the processor is configured to estimate changes in non-electrochemical properties of the liquid, chemistry of the liquid, and/or microbial content of the liquid based on the parameters of the dynamic model, the set of latent variables, and/or the changes in electrochemical properties of the liquid.

8. The electrochemical sensor of claim 6, wherein the processor is further configured to predict a future trajectory of changes to the parameters of the dynamic model, the set of latent variables, and/or the changes in electrochemical properties of the liquid.

9. The electrochemical sensor of claim 1, further comprising:
a temperature sensor, operably coupled to the processor, to measure a temperature of the liquid.

10. The electrochemical sensor of claim 1, further comprising:
a temperature controller, operably coupled to the processor, to control a temperature of the liquid.

11. The electrochemical sensor of claim 1, wherein the pair of electrodes is one of a plurality of pairs of electrodes and further comprising:
a plurality of sample chambers, each containing a different liquid sample and different one of the plurality of pairs of electrodes.

12. A method of monitoring electrochemical properties of a liquid, the method comprising:
generating a stochastic waveform;
applying the stochastic waveform to the liquid with a pair of electrodes;
measuring current flowing through the liquid between the pair of electrodes and/or voltage across the pair of electrodes in response to the stochastic waveform;
creating a dynamic model characterizing a relationship between the current and/or voltage and the stochastic waveform in the liquid; and
estimating changes in the electrochemical properties of the liquid based on changes in parameters of the dynamic model.

13. The method of claim 12, wherein generating the stochastic waveform comprises generating the stochastic waveform with an amplitude greater than an amplitude at which Faradaic reactions and specific adsorption occur in the liquid.

14. The method of claim 12, wherein generating the stochastic waveform comprises generating the stochastic waveform with a bandwidth spanning from about 1 Hz to about 1 MHz.

15. The method of claim 12, wherein creating the dynamic model comprises creating a linear dynamic element and a nonlinear dynamic element.

16. The method of claim 12, further comprising:
estimating a set of latent variables that concisely describe complex changes to the parameters of the dynamic model.

17. The method of claim 16, further comprising:
estimating changes in non-electrochemical properties of the liquid, chemistry of the liquid, and/or microbial content of the liquid based on the parameters of the dynamic model, the set of latent variables, and/or the changes in electrochemical properties of the liquid.

18. The method of claim 17, further comprising:
predicting a future trajectory of changes to the parameters of the dynamic model, the set of latent variables, the changes in electrochemical properties of the liquid, the non-electrochemical properties of the liquid, the chemistry of the liquid, and/or the microbial content of the liquid.

19. The method of claim 12, further comprising:
measuring a temperature of the liquid.

20. The method of claim 12, further comprising:
controlling a temperature of the liquid.
